(19) United States
(12) Patent Application Publication
(10) Pub. No.: US 2026/0093339 A1
(43) Pub. Date: Apr. 2, 2026

(54) CONTROLLING A STATE OF A PHYSICAL OBJECT BASED ON A GESTURE

(71) Applicant: Apple Inc., Cupertino, CA (US)

(72) Inventors: Yutaka Yokokawa, Los Gatos, CA (US); Alexandria G. Heston, San Francisco, CA (US); Anrutha Hakkare Arunachala, Sunnyvale, CA (US); In Young Yang, Kirkland, WA (US); Joshua J. Frost, Aptos, CA (US); Magnus H. Johnson, San Francisco, CA (US)

(21) Appl. No.: 19/340,016

(22) Filed: Sep. 25, 2025

Related U.S. Application Data
(60) Provisional application No. 63/699,901, filed on Sep. 27, 2024.

(51) Int. Cl. G06F 3/01; G06F 3/16; G06V 40/10; G06V 40/20

(52) U.S. Cl. CPC G06F 3/017; G06F 3/013; G06F 3/167; G06V 40/10; G06V 40/28

(57) ABSTRACT

A method includes obtaining, via an eye tracker, a gaze input directed to a physical object that is operable in a first state or a second state. The physical object is currently in the first state. The method includes detecting a gesture performed by a user of the device while the gaze input is directed to the physical object. The method includes switching the physical object from the first state to the second state in response to the gesture satisfying a state change criterion associated with the second state.

### CROSS-REFERENCE TO RELATED APPLICATIONS

This application claims priority to U.S. Provisional Patent App. No. 63/699,901, filed on Sep. 27, 2024, which is incorporated by reference in its entirety.

### TECHNICAL FIELD

The present disclosure generally relates to controlling a state of a physical object based on a gesture.

### BACKGROUND

Some physical objects are associated with multiple states. Such physical objects can switch between states upon receiving an input. For example, a window blind can be switched between an open state and a closed state. Controlling the state of a physical object often requires a physical manipulation of the physical object or a control device. For example, switching the window blind from an open state to a closed state often requires a physical manipulation of the window blind or pressing a button on a remote control for the window blind.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1AJ are diagrams of an example environment in accordance with some implementations.

FIG. 2 is a block diagram of a system that controls a state of a physical object in accordance with some implementations.

FIG. 3 is a flowchart representation of a method of controlling a state of a physical object in accordance with some implementations.

FIG. 4 is a block diagram of a device that controls a state of a physical object in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for controlling a state of a physical object based on a gesture. In some implementations, a device includes an eye tracker, a display, non-transitory memory and one or more processors. In various implementations, a method includes obtaining, via the eye tracker, a gaze input directed to a physical object that is operable in a first state or a second state. In some implementations, the physical object is currently in the first state. In some implementations, the method includes detecting a gesture performed by a user of the device while the gaze input is directed to the physical object. In some implementations, the method includes switching the physical object from the first state to the second state in response to the gesture satisfying a state change criterion associated with the second state.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

Some devices allow a user to control other physical objects using gaze as an input. For some objects, gaze may be sufficient to trigger a state change. However, for other objects gaze on its own may lead to undesirable state changes. For example, the user may gaze at blinds to make sure that they are closed. However, a gaze-only trigger may inadvertently trigger the blinds to open.

The present disclosure provides methods, systems, and/or devices for controlling a state of a physical object based on a gesture. A device detects a gaze input directed to a physical object that can be switched between two or more states. For example, the device detects that a user of the device is gazing at a window shade that can be rolled between an open state, a closed state, and various intermediary states that are between the open state and the closed state. In order to prevent changing a state of an object inadvertently, the device requires a gaze input and a gesture for switching the state of the object. For example, opening or closing blinds may require a gaze input and a blind-specific gesture (e.g., hand being waved upwards or downwards).

In order to further prevent inadvertent changes in a state of an object, the gesture required to trigger the state change in the object has to be a particular type of gesture that matches how the object's state changes. For example, if a window shade moves in a vertical direction to switch between the open state and the closed state, the gesture for triggering a state change in the window shade includes a vertical component (e.g., a vertical dragging of a hand of the user or a vertical nod of a head of the user).

If the object or a portion of the object performs a particular movement to change states, the gesture has to match the particular movement that the object performs in order to trigger a state change in the object. For example, if the object is a fan with fan blades that rotate, the gesture for turning the fan on includes a rotating gesture where the user rotates his/her index finger along a circular path. A gesture that does not match the particular movement of the object does not trigger a state change in the object. For example, a vertical dragging gesture may not trigger the fan blades to begin rotating.

If the object makes a particular sound while switching states or while operating in a particular state, the gesture for triggering the object to switch into that particular state may include an utterance that matches the particular sound that the object makes. For example, if the fan makes a low-pitched whirling sound that is within a particular frequency range, a voice gesture that is similar to the low-pitched whirling sound that the fan makes can trigger the fan to switch from an off state to an on state. However, a voice gesture that is not similar to the low-pitched whirling sound of the fan may not trigger the fan to turn on. For example, a high-pitched clicking sound may not trigger the fan to turn on.

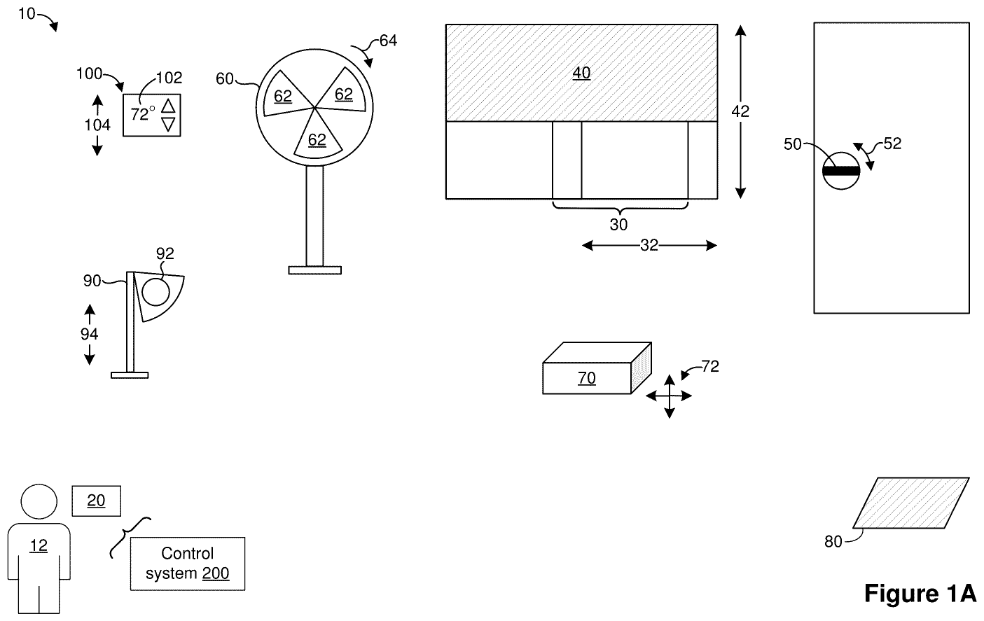

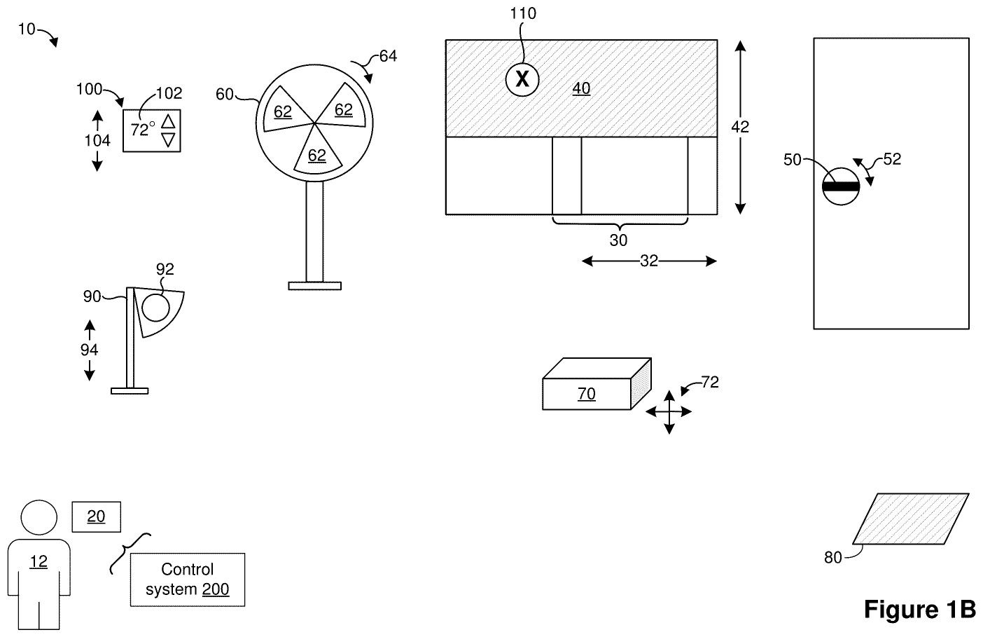

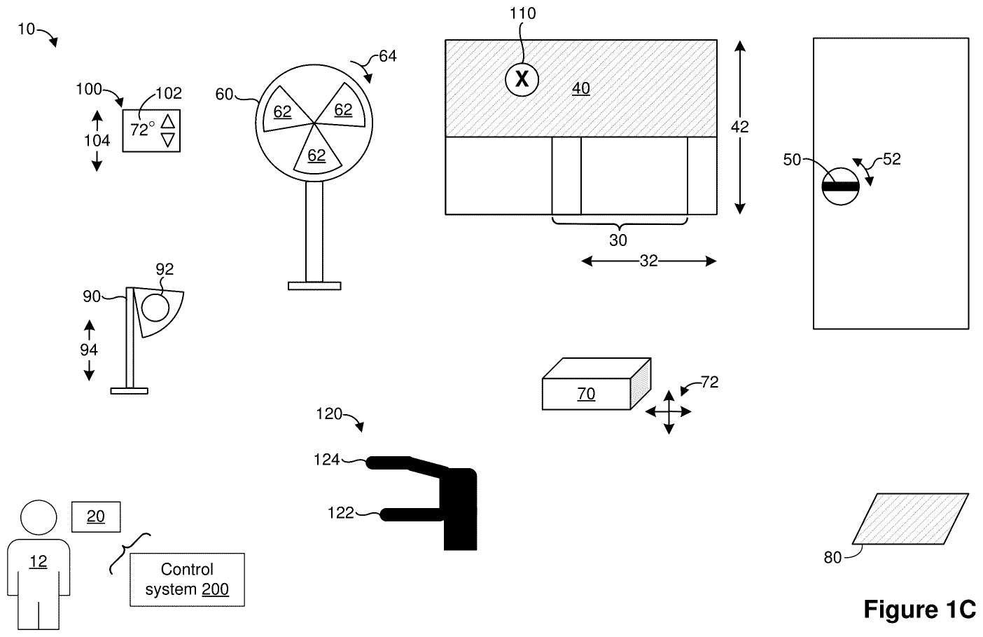

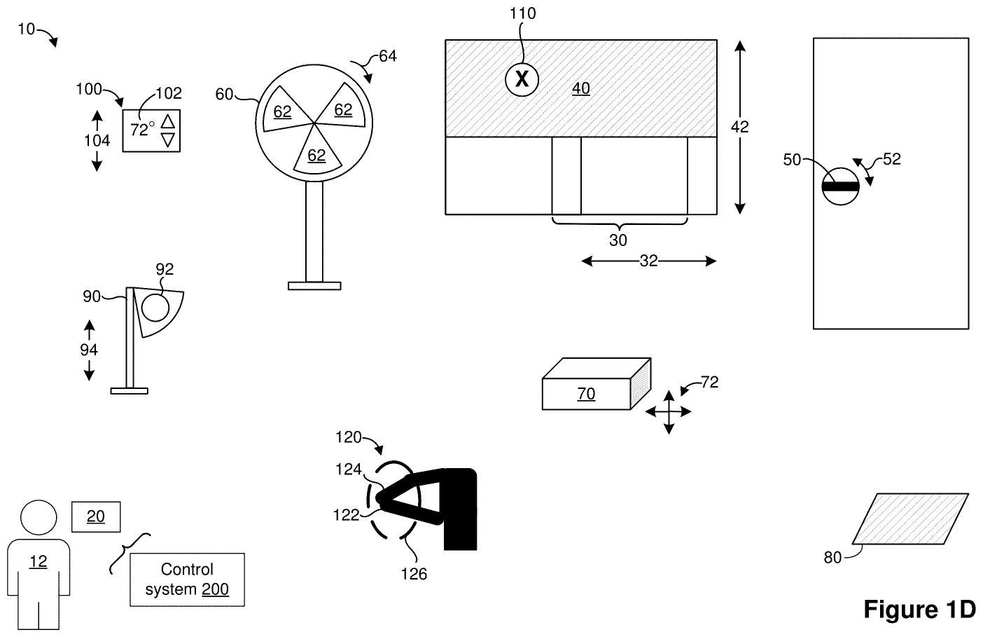

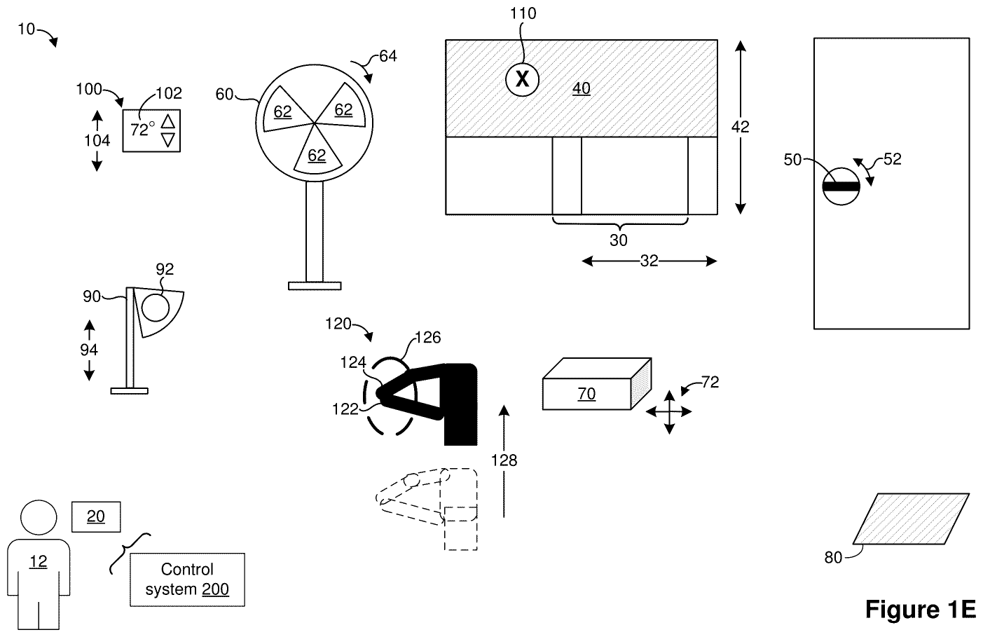

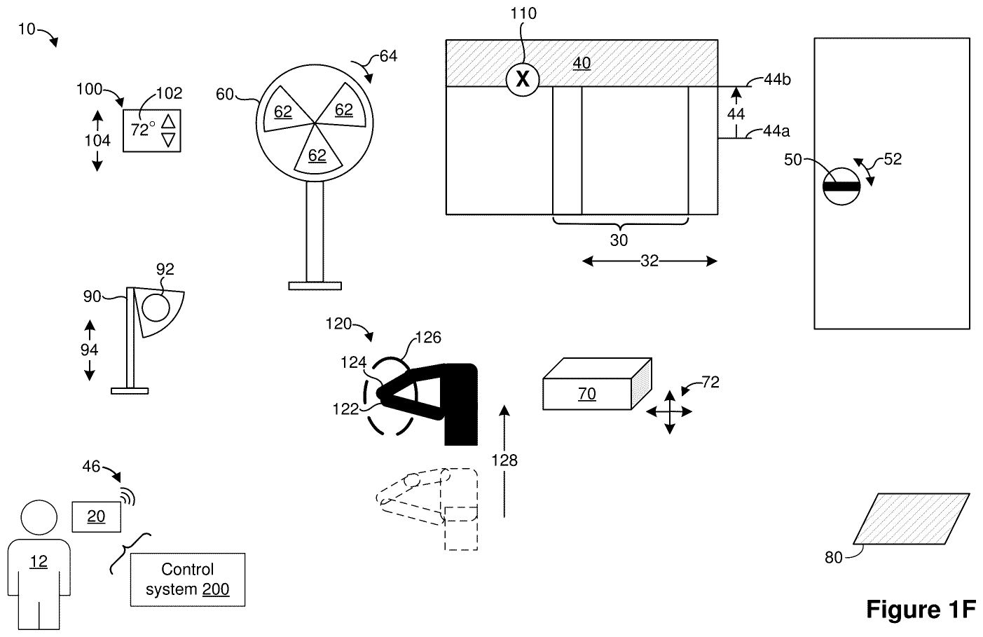

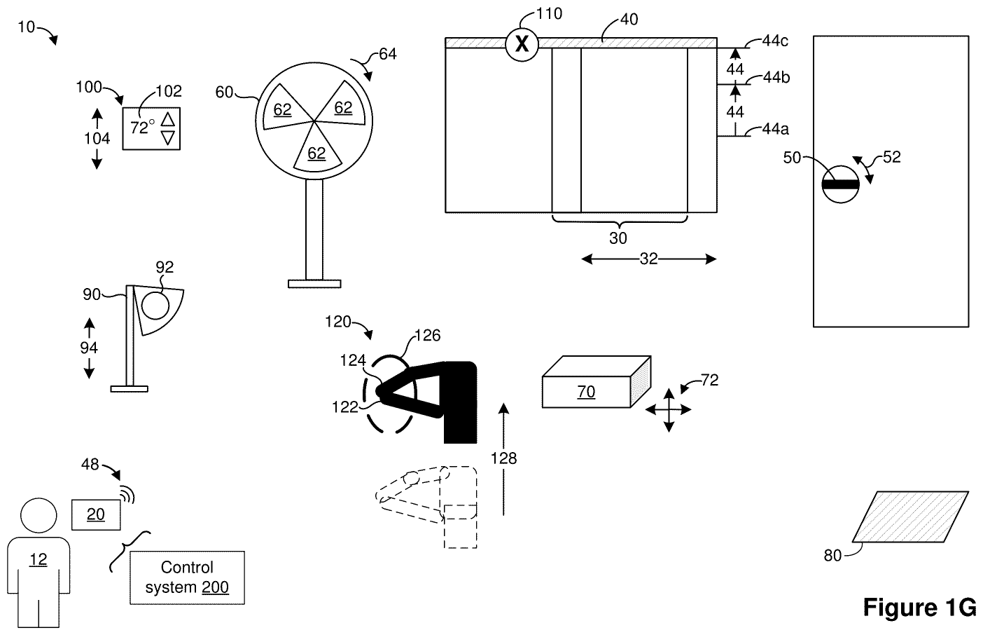

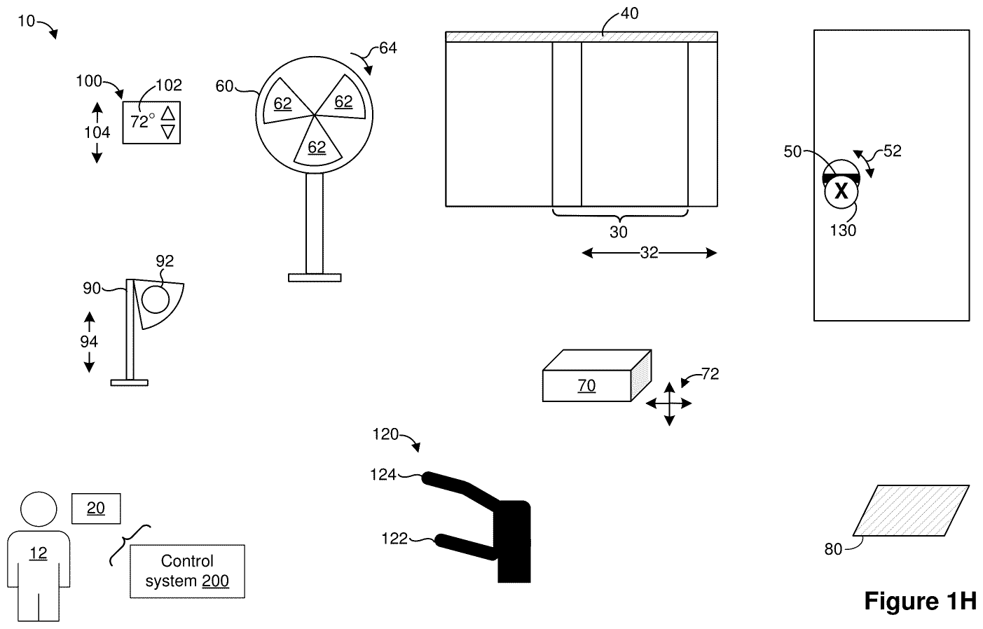

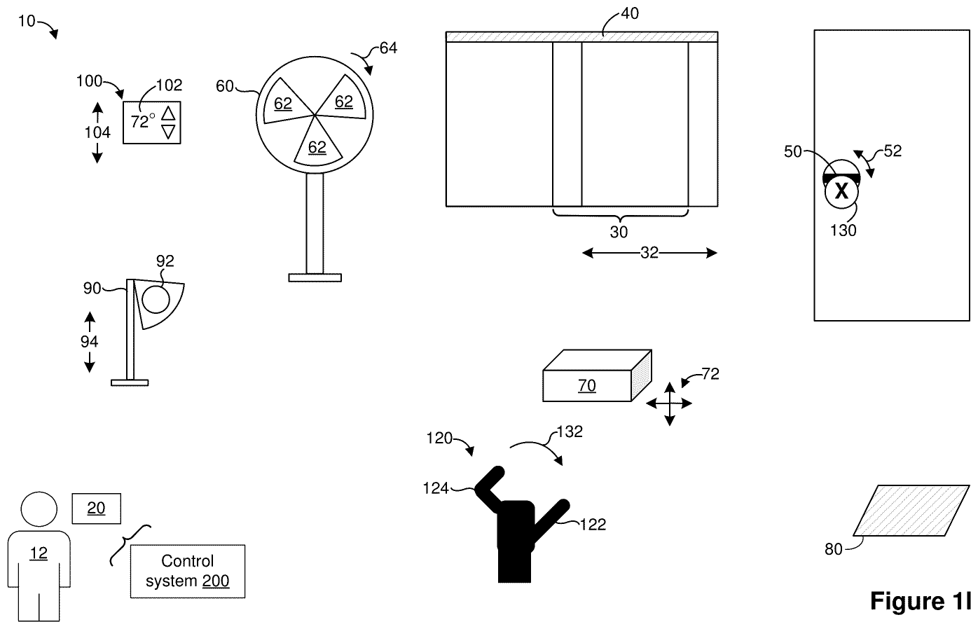

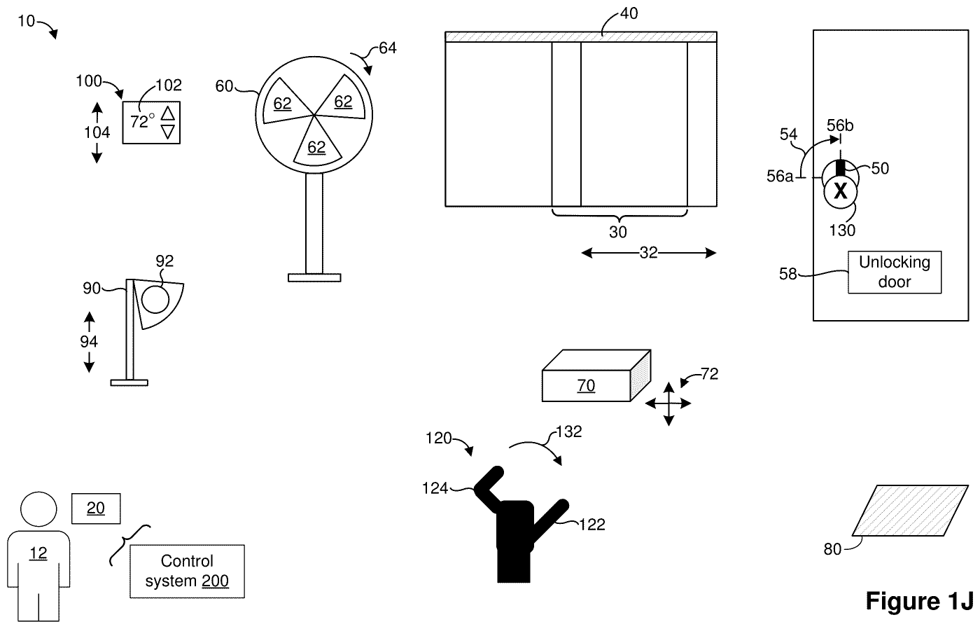

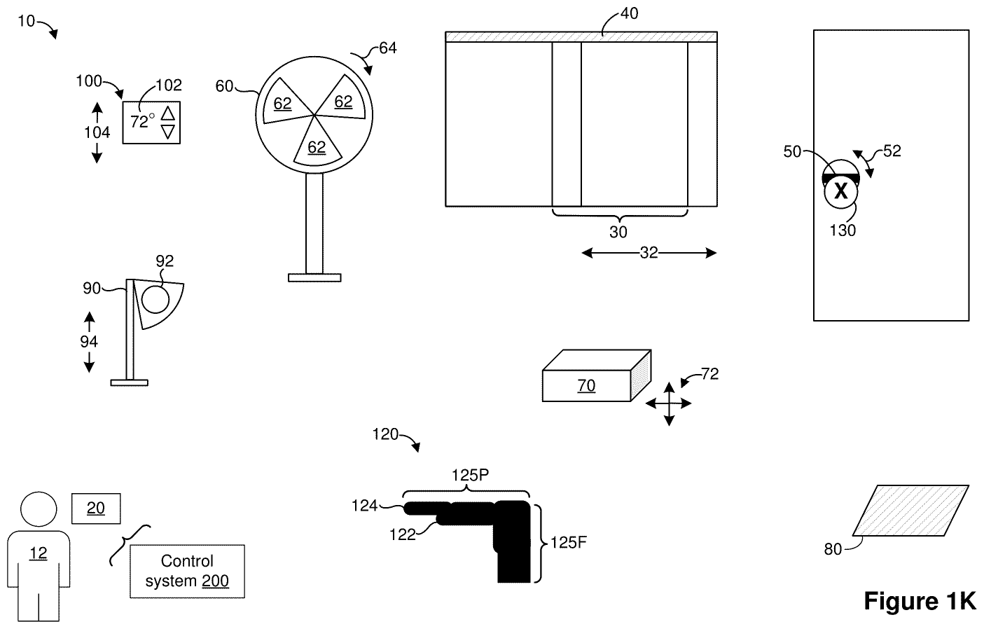

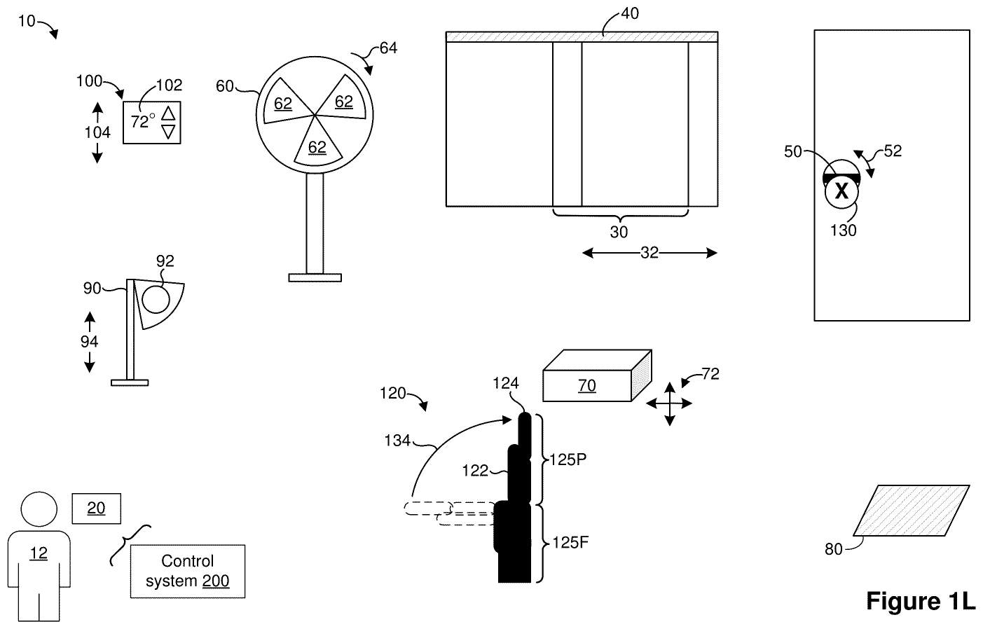

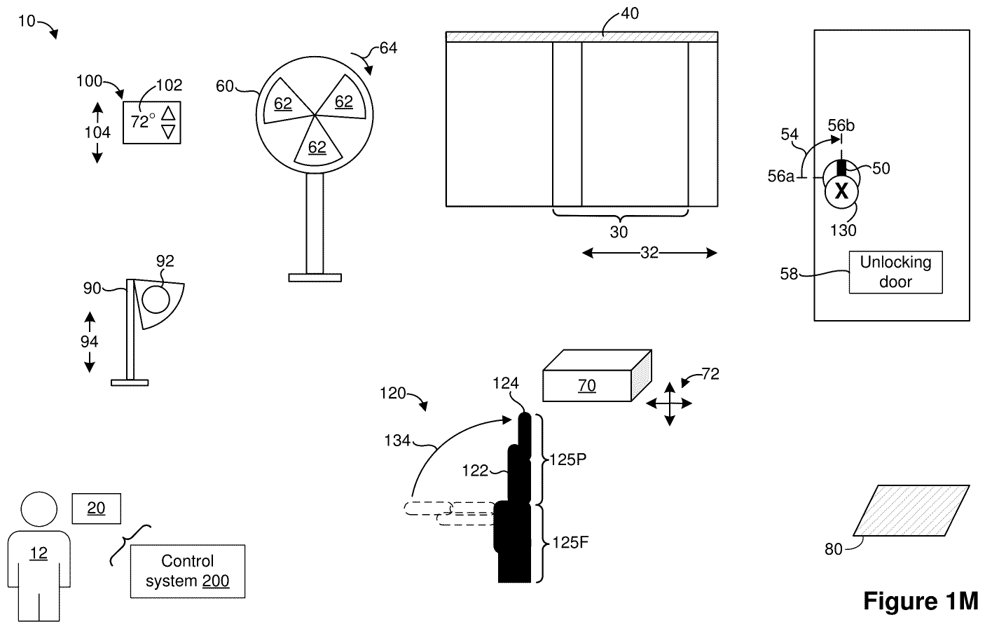

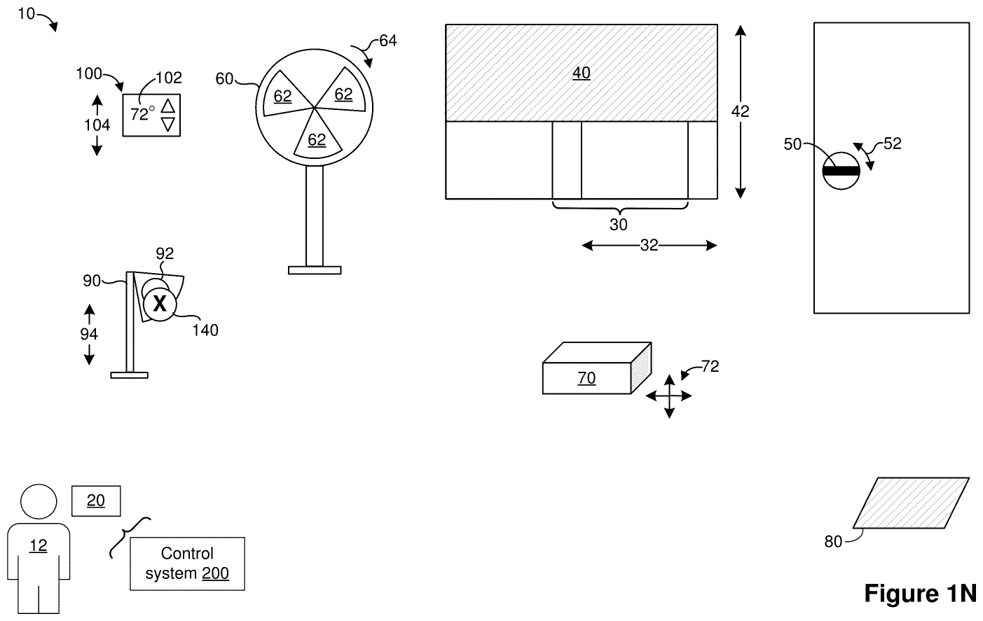

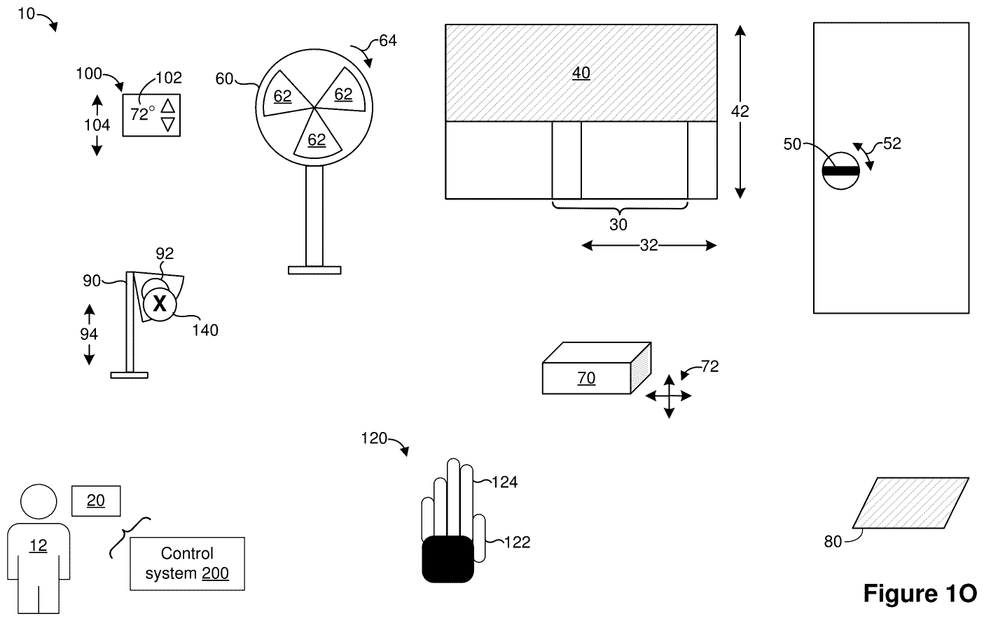

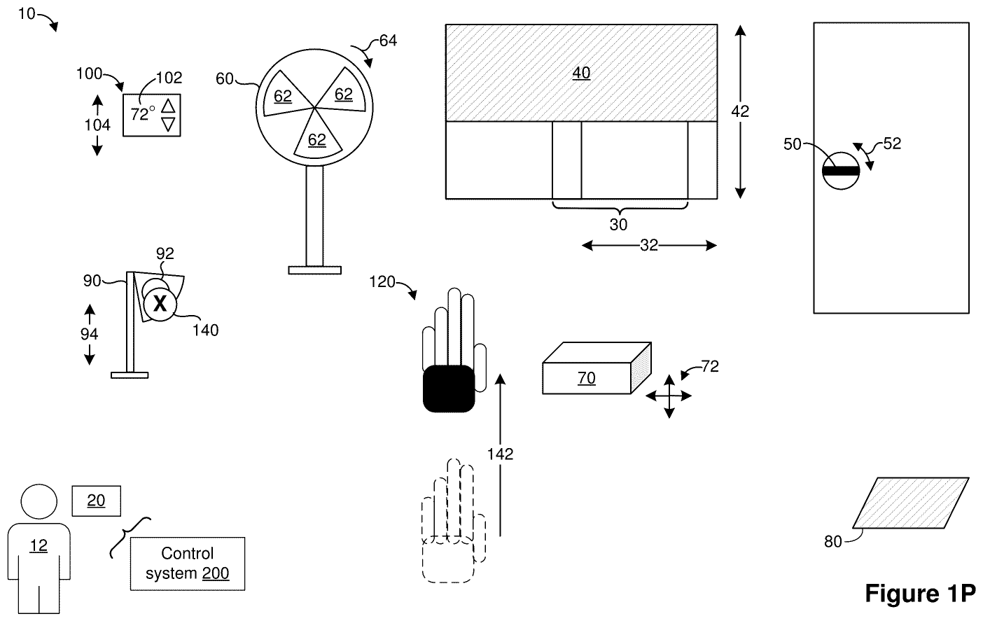

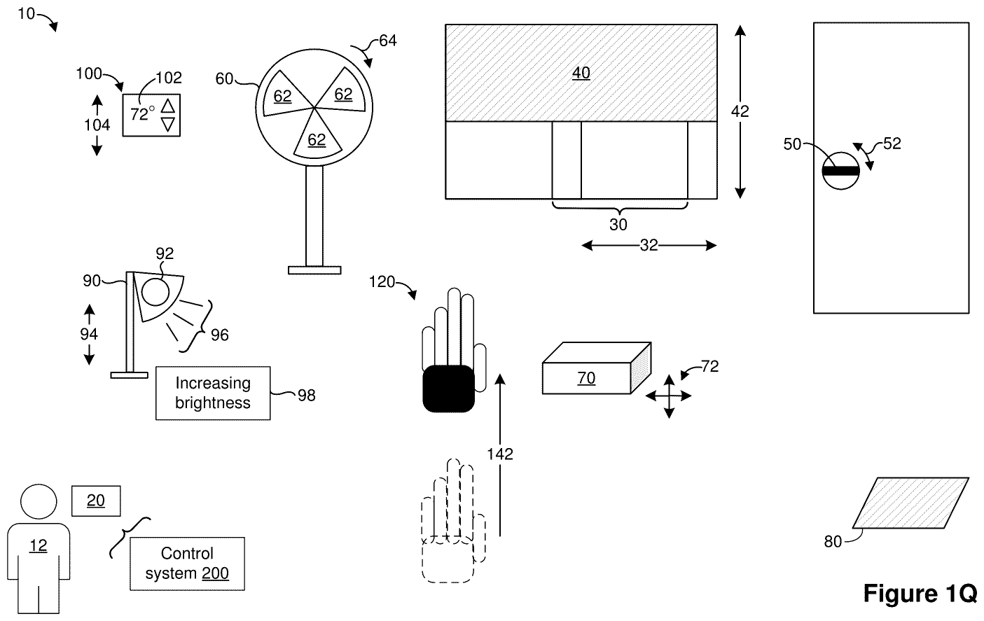

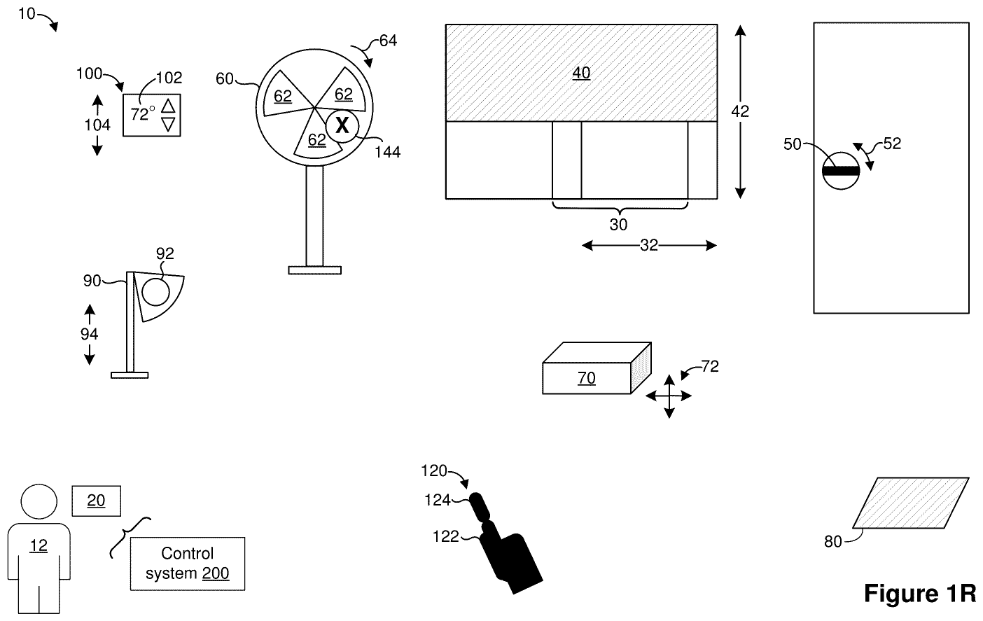

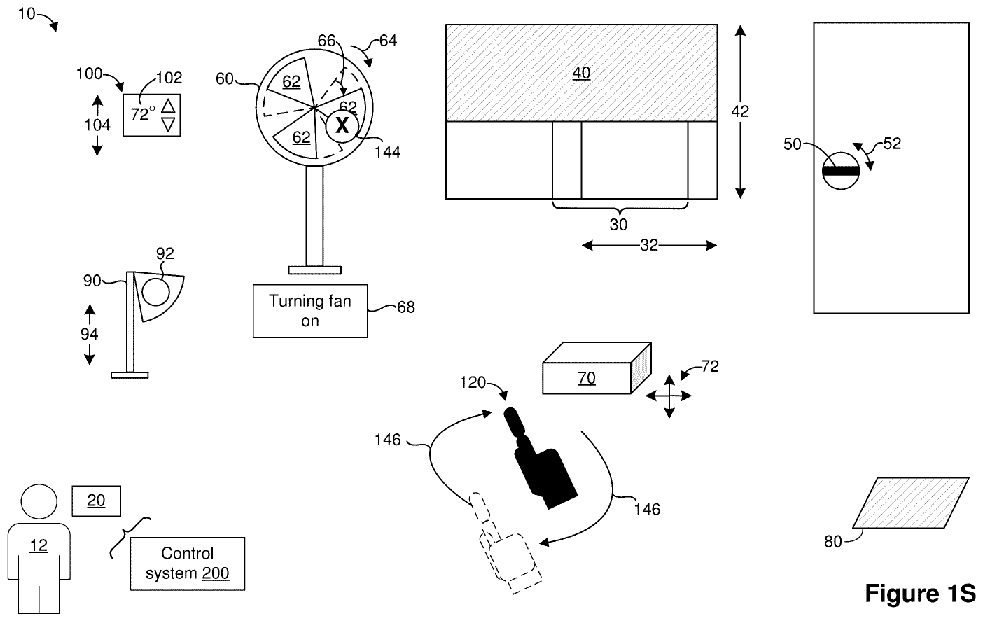

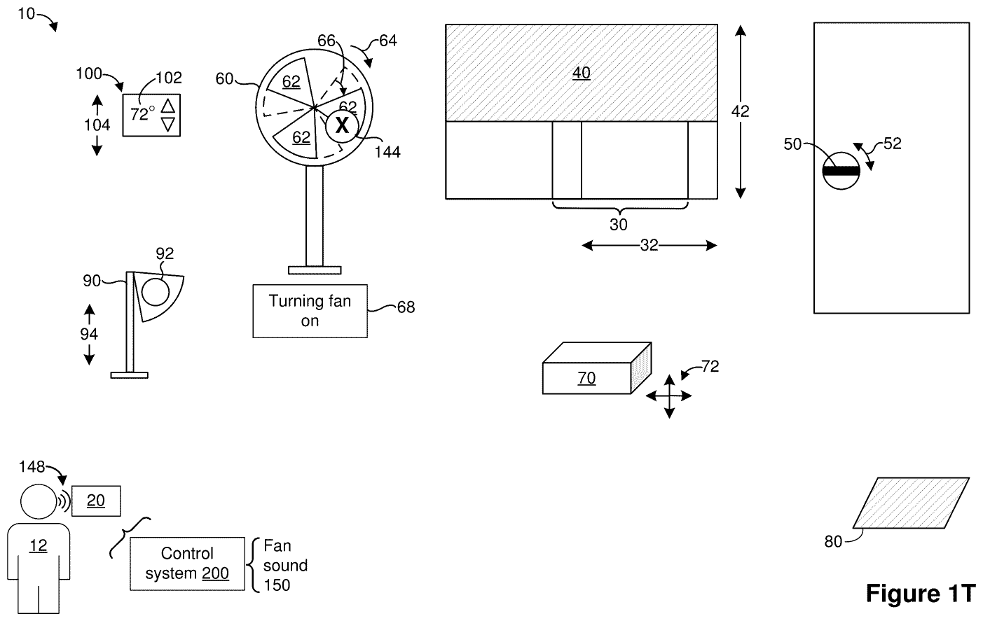

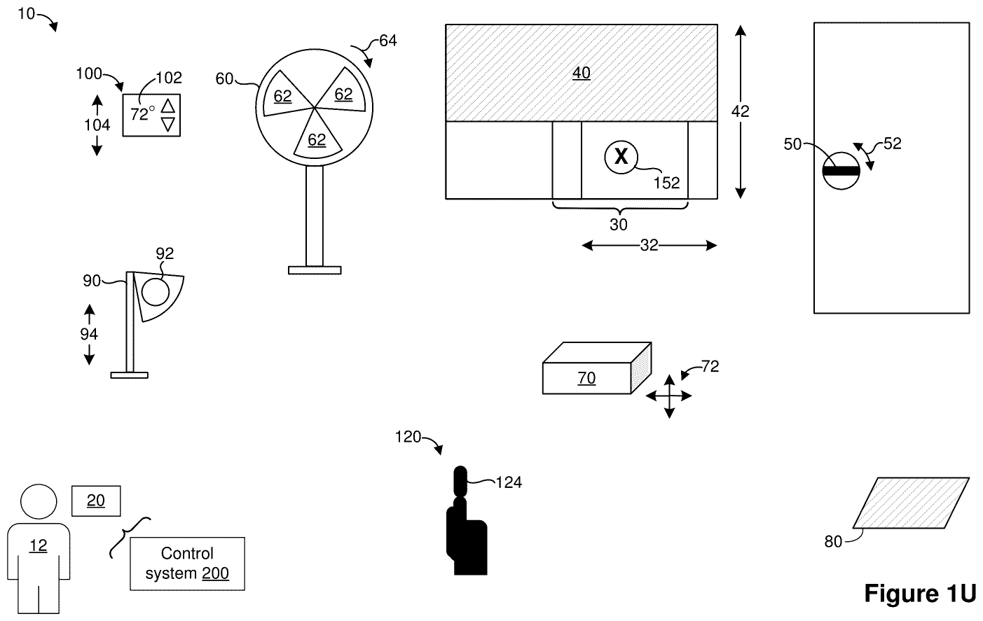

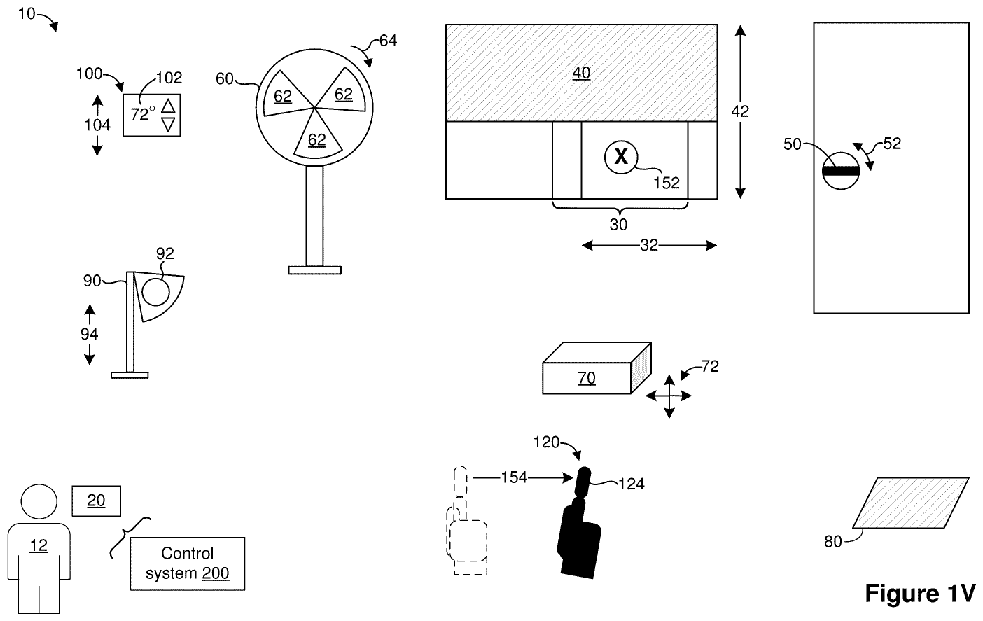

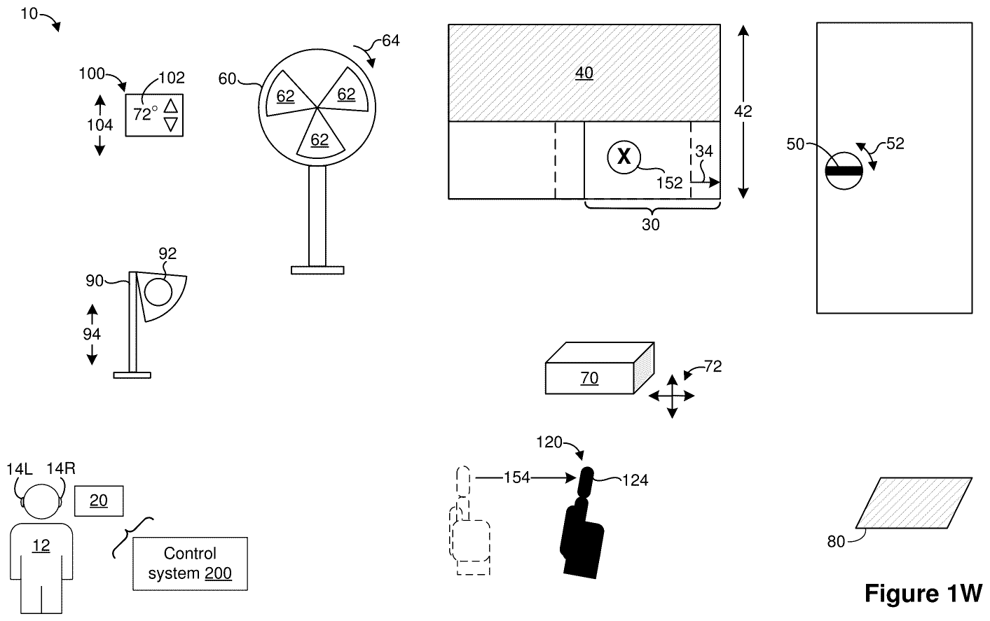

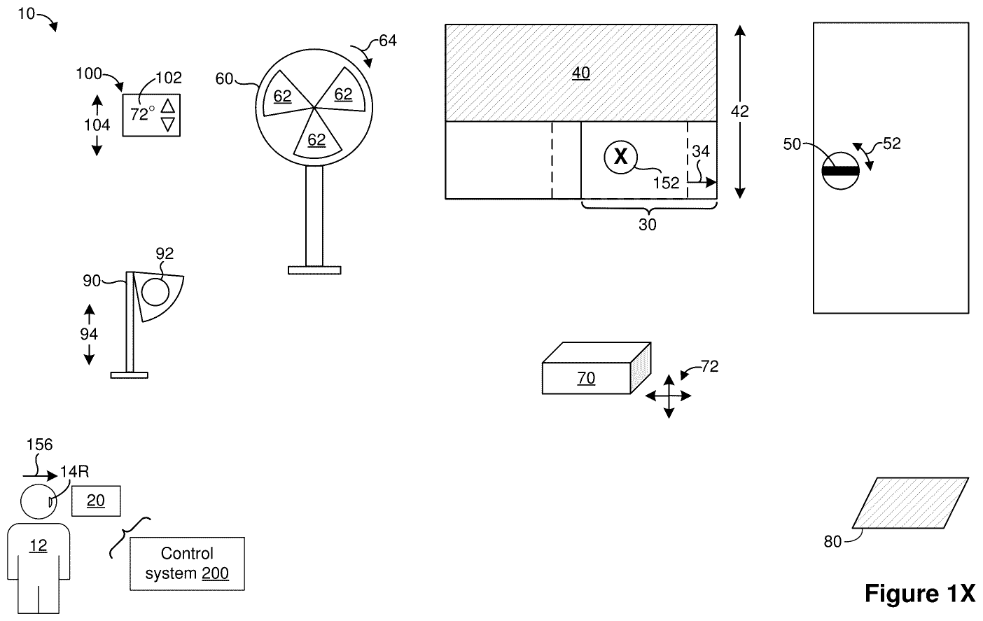

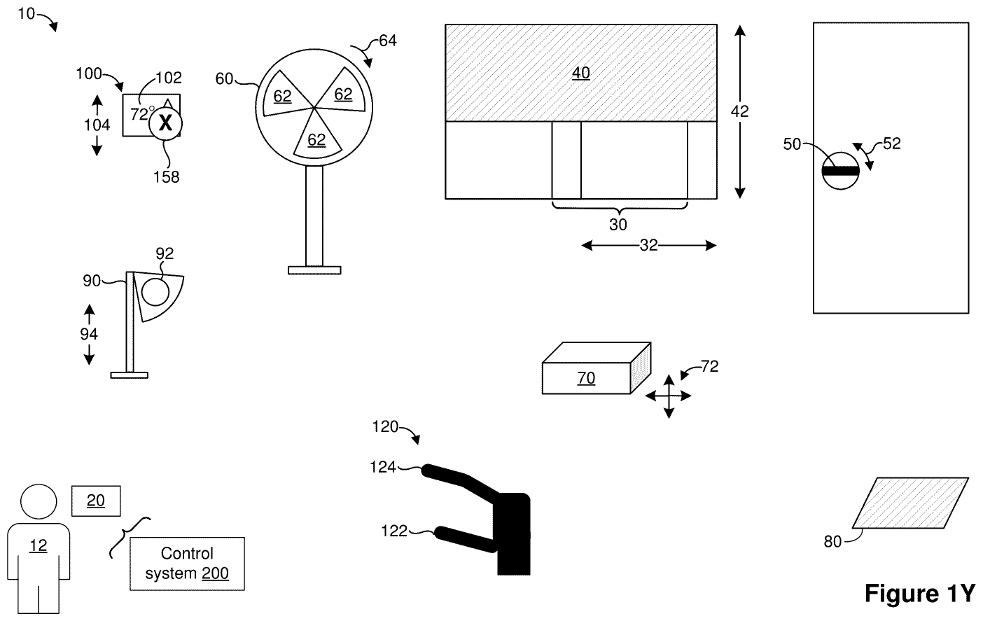

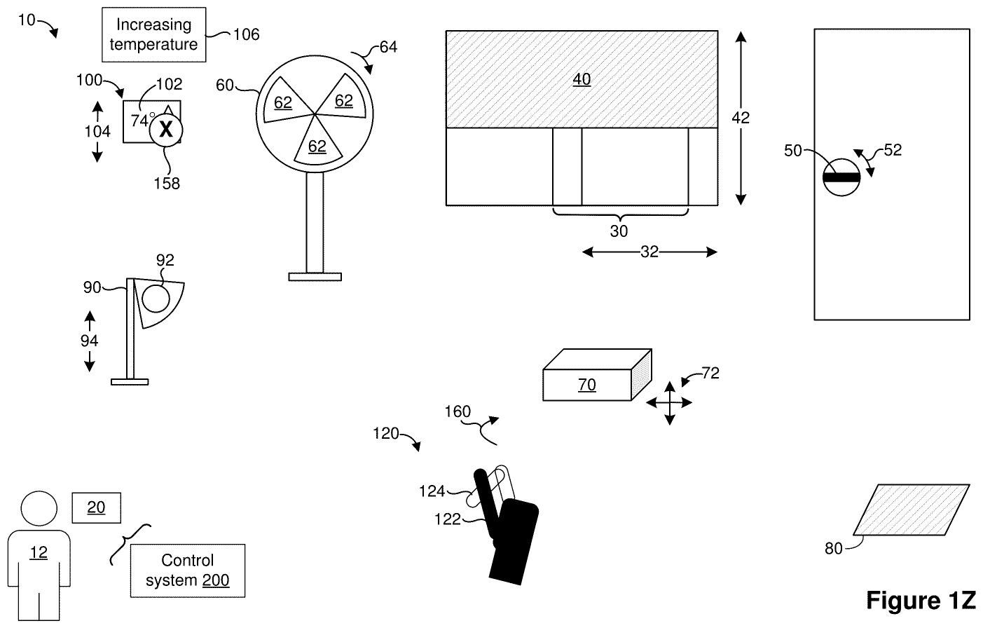

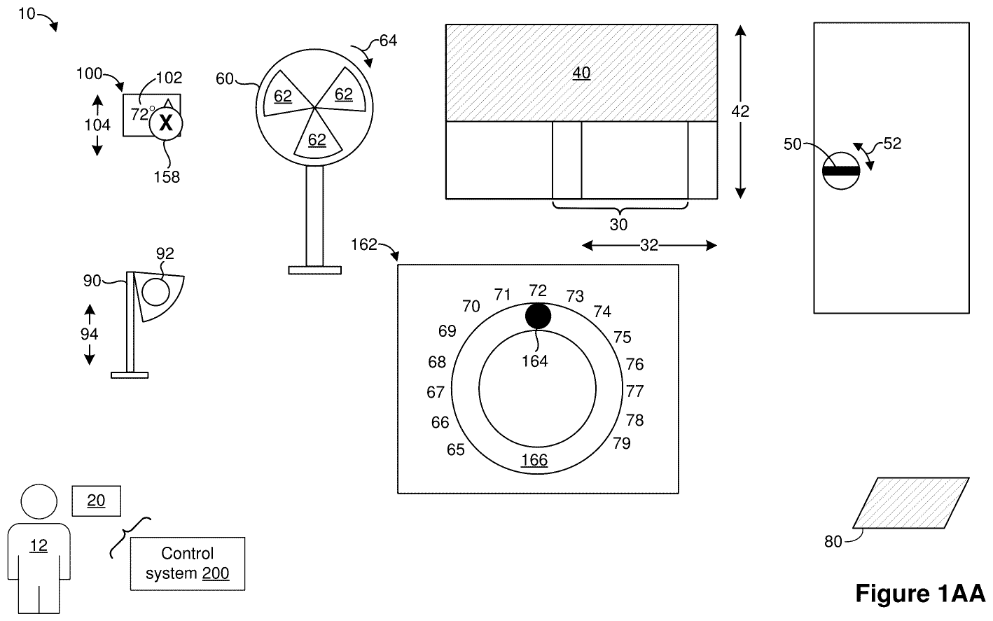

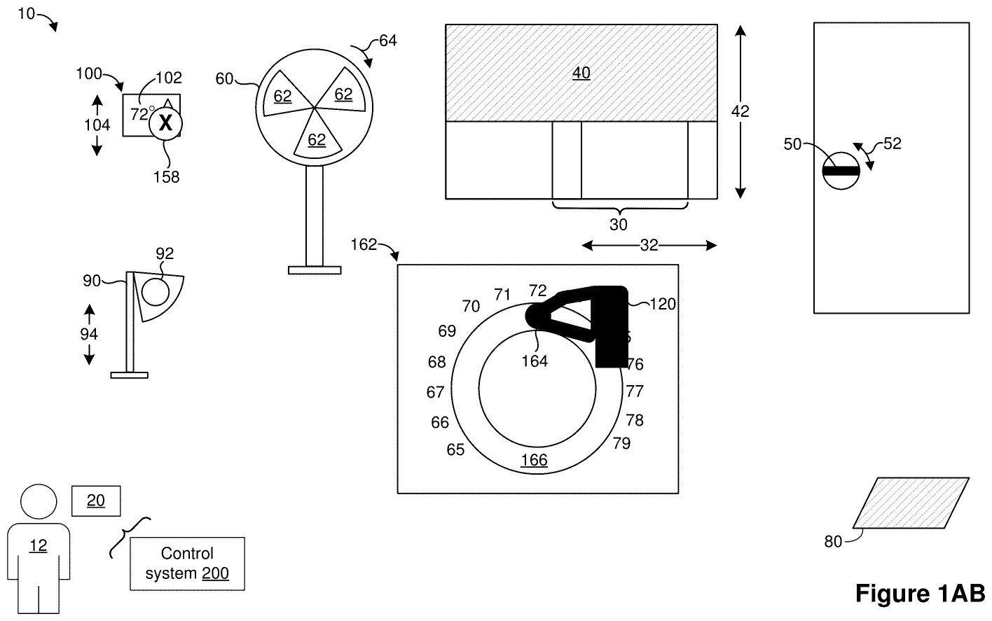

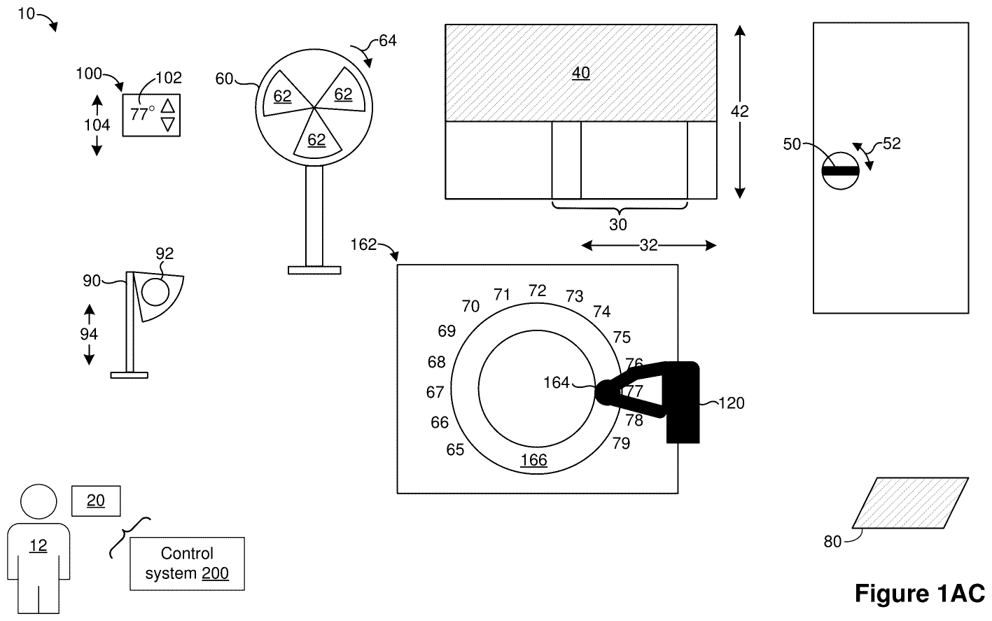

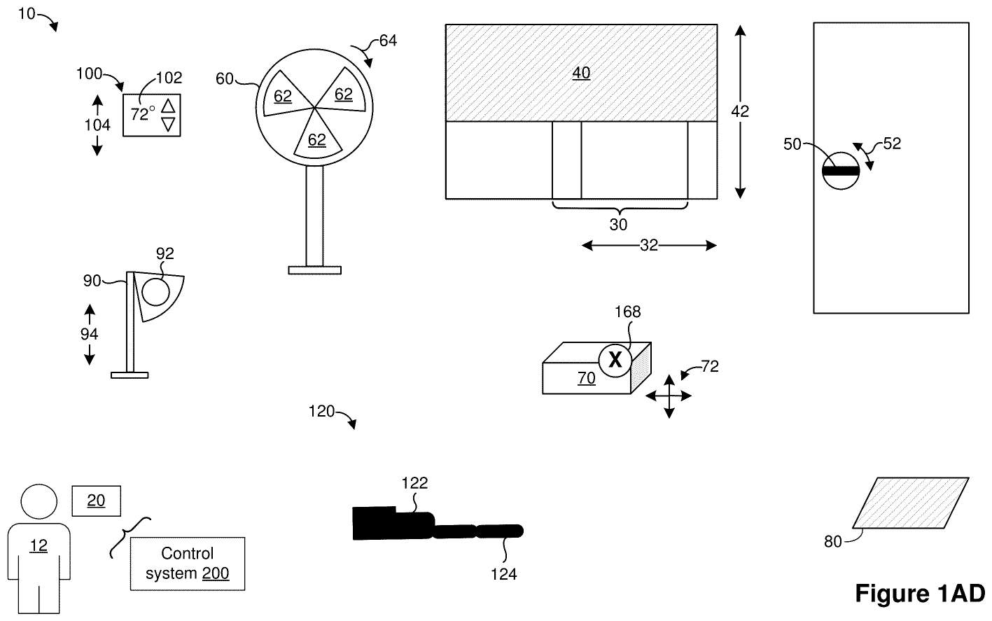

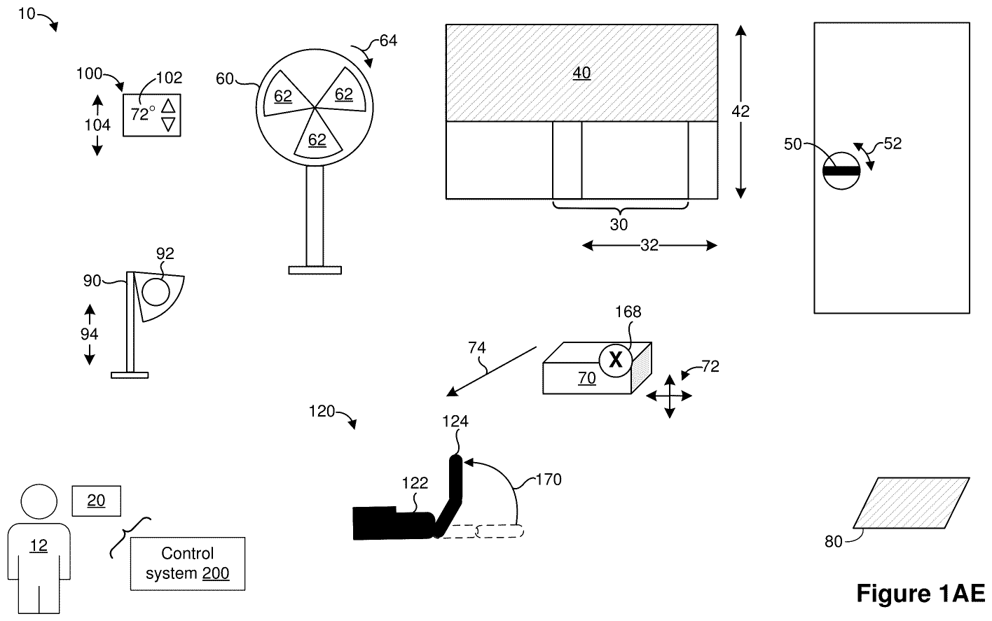

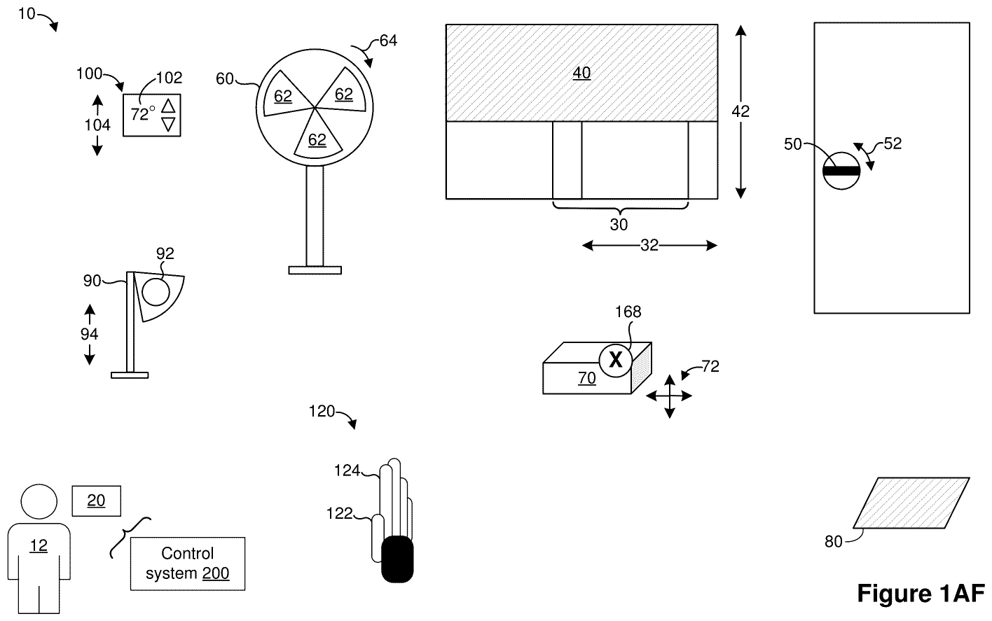

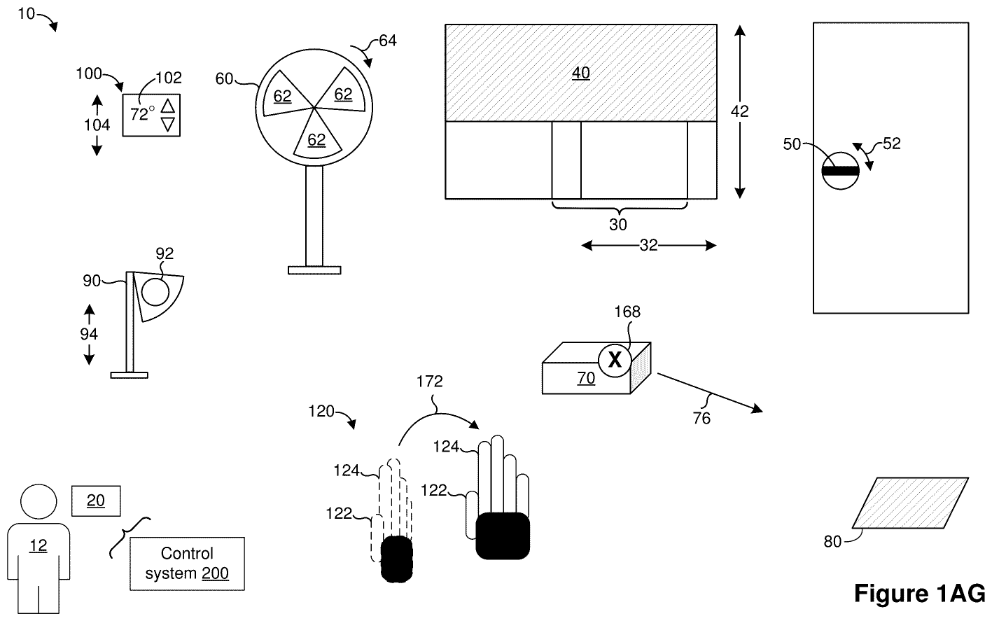

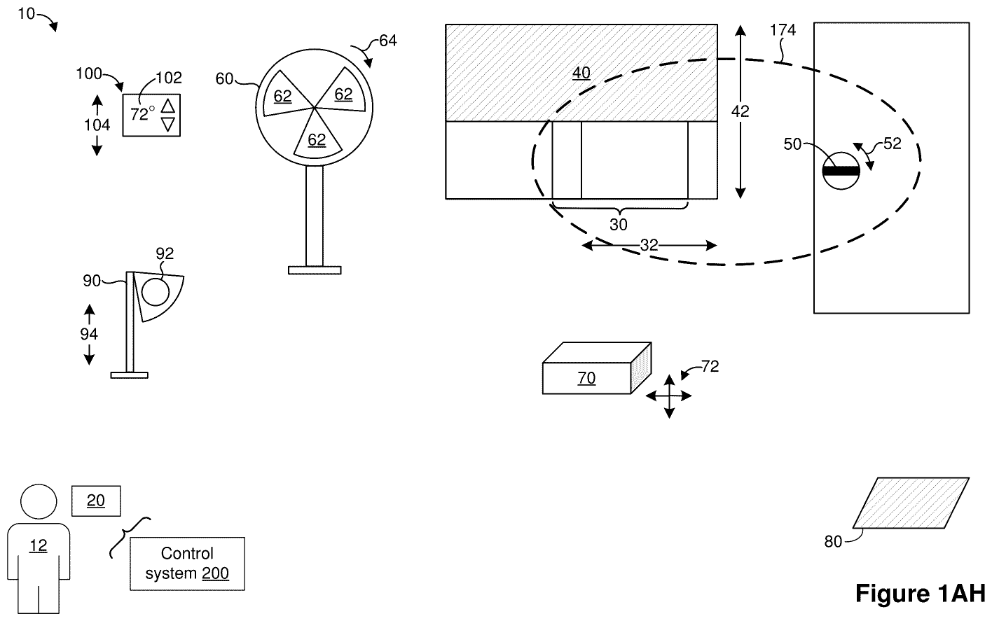

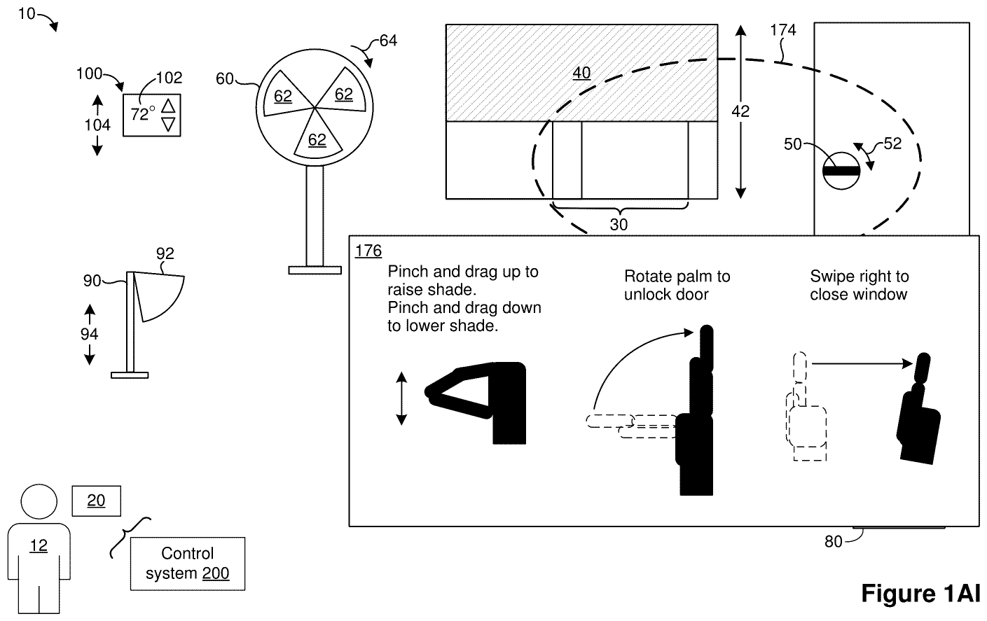

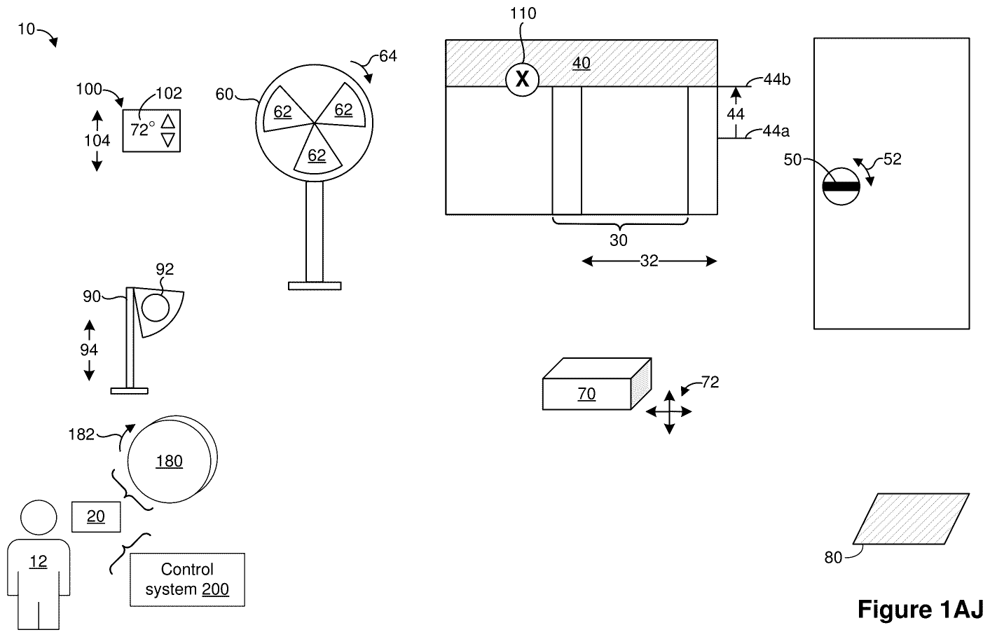

FIG. 1A is a diagram that illustrates an example physical environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. In various implementations, the physical environment 10 includes a user 12, an electronic device 20 (“device 20”, hereinafter for the sake of brevity) and various physical objects that can switch between two or more states. In the example of FIG. 1A, the physical environment 10 includes a window 30, a window shade 40, a door lock 50, a fan 60, a robot 70, a dock 80 for the robot 70, a lamp 90 and a thermostat 100.

In various implementations, the window 30 moves in a horizontal direction indicated by a horizontal arrow 32. The window 30 slides between an open position, a closed position and various intermediate positions that are between the open position and the closed position. In some implementations, the window 30 is connected to an actuator that applies a force on the window 30 in order to slide the window 30 in the horizontal direction in response to wirelessly receiving a command from the device 20.

In some implementations, the window shade 40 moves in a vertical direction indicated by a vertical arrow 42. The window shade 40 moves (e.g., rolls) between an open position, a closed position and various intermediate positions that are between the open position and the closed position. In some implementations, the window shade 40 is connected to a motor that applies a force on the window shade 30 in order to roll the window shade 40 in the vertical direction in response to wirelessly receiving a command from the device 20.

In some implementations, the door lock 50 rotates between a locked position and an unlocked position as indicated by a curved arrow 52. In some implementations, the door lock 50 is connected to an actuator that applies a force on the door lock 50 to rotate the door lock 50 between the locked position and the unlocked position.

In some implementations, the fan 60 includes fan blades 62 that rotate in a direction indicated by a curved arrow 64. In some implementations, the fan 60 includes a wireless controller that triggers the fan 60 to switch between an off position in which the fan blades 62 are not rotating to an on position in which the fan blades 62 are rotating. In some implementations, the fan blades 62 can operate at multiple speeds that are controlled by the wireless controller. In some implementations, the wireless controller receives a command to change the state of the fan 60 from the device 20.

In some implementations, the robot 70 moves in various directions indicated by arrows 72. As will be illustrated in FIG. 1AE, the user 12 can perform a beckoning gesture or an invitation gesture while gazing at the robot 70 to trigger the robot 70 to move towards the user 12. As will be illustrated in FIG. 1AG, the user 12 can perform a repelling gesture or a dismissal gesture while gazing at the robot 70 to trigger the robot 70 to move to the dock 80 so that a battery of the robot can be charged. To that end, the robot 70 includes a wireless controller that accepts commands from the device 20.

In some implementations, the lamp 90 includes a light bulb 92. A brightness value of the light bulb can be increased or decreased as indicated by a bi-directional vertical arrow 94. In some implementations, the lamp 90 or the light bulb 92 includes circuitry that wirelessly receives a command from the device 20 to turn on the light bulb 92, turn off the light bulb 92 or to adjust a brightness value of the light bulb 92.

In some implementations, the thermostat 100 controls a temperature value 102 of the physical environment 10. As indicated by a bi-directional vertical arrow 104, the temperature value 102 can be increased or decreased. The thermostat 100 includes circuitry that wirelessly receives a command from the device 20 to increase or decrease the temperature value 102.

In various implementations, the device 20 includes a control system 200 (“system 200”, hereinafter for the sake of brevity) that allows the user 12 to control the various physical objects in the physical environment 10 based on gaze and gesture inputs.

In some implementations, the device 20 includes a handheld computing device that can be held by the user 12. For example, in some implementations, the device 20 includes a smartphone, a tablet, a media player, a laptop, or the like. In some implementations, the device 20 includes a wearable computing device that can be worn by the user 12. For example, in some implementations, the device 20 includes a head-mountable device (HMD) or an electronic watch.

In some implementations, the device 20 includes a display (not shown) for presenting content. In some implementations, the device 20 displays a graphical user interface (GUI) on the display. As illustrated in FIGS. 1J, 1Q, 1S and 1Z, in some implementations, the device 20 displays a notification within the GUI indicating a state change that is about to occur with respect to one of the physical objects in the physical environment 10. As illustrated in FIG. 1AI, in some implementations, the notification includes a user guide for changing a state of a physical object by performing an object-specific gesture.

FIGS. 1B-1G illustrate a sequence for controlling the window shade 40. Referring to FIG. 1B, the device 20 detects a gaze input 110 directed to the window shade 40. In the example of FIG. 1B, the window shade 40 is half-drawn (e.g., half-open or half-closed). The gaze input 110 on its own is insufficient to trigger a state change in the window shade 40 because the gaze input 110 on its own is insufficient to determine an intent of the user 12. For example, the device 20 may not be able to determine whether the user 12 intends to move the window shade 40 towards an open position or a closed position based solely on the gaze input 110. As such, in addition to the gaze input 110, the device 20 requires a gesture in order to determine whether to change a state of the window shade 40 and what state change to perform. In some implementations, the device 20 detects the gaze input 110 by analyzing a set of one or more images captured by a user-facing image sensor (e.g., via an eye tracker).

Referring to FIG. 1C, the device 20 detects a hand 120 of the user 12. The hand 120 includes a thumb 122 and an index finger 124. Other fingers are not shown. In some implementations, the device 20 includes a body tracker (e.g., an image sensor that faces towards a hand of the user 12) that detects the hand 120.

Referring to FIG. 1D, the device 20 detects an air tap gesture 126 that includes a contact between the thumb 122 and the index finger 124. In some implementations, the air tap gesture 126 is still not enough to determine whether the user 12 wants to open the window shade 40 further or close the window 40 completely. As such, the system 200 may not trigger a state change in the window shade 40 in response to the air tap gesture 126.

In some implementations, a display location of the air tap gesture 126 corresponds to (e.g., overlaps with) a display location of a handle of the window shade 40. In such implementations, the air tap gesture 126 corresponds to the user 12 grabbing the handle of the window shade 40. The device 20 may display a visual indicator proximate to the handle in order to indicate that the user 12 has virtually grabbed the handle of the window shade 40.

Referring to FIG. 1E, the device 20 detects a drag gesture 128 by detecting an upward movement of the hand 120 in a vertical direction that matches the vertical arrow 42.

Referring to FIG. 1F, since a movement of the drag gesture 128 matches how the window shade 40 moves, the system 200 determines that the user 12 intends to further open the window shade 40. As such, the system 200 transmits an open command to a wireless controller of the window shade 40. The wireless controller controls a motor or an actuator connected to the window shade 40 and triggers a vertical movement 44 of the window shade 40 from a first position 44a to a second position 44b. In some implementations, the device 20 plays a shade lifting sound effect 46 through a speaker of the device 20 (e.g., a high-pitched motor spinning sound).

Referring to FIG. 1G, the user 12 continues the drag gesture 128 by dragging his/her hand 120 upwards while maintaining the air tap gesture 126. In response to a continuance of the drag gesture 128, the system 200 opens the window shade 40 further until the window shade 40 reaches a third position 44c that corresponds to the window shade 40 being fully open. In some implementations, the device 20 plays a shade lifted sound effect 48 that is different from the shade lifting sound effect 46 (shown in FIG. 1F) when the window shade 40 reaches a fully open position and cannot be lifted further (e.g., a sequence of beeps).

FIGS. 1B-1G illustrate how the user 12 can control the window shade 40 using the drag gesture 128 that mimics how the window shade 40 moves. In some implementations, the system 200 does not trigger the window shade 40 to open further when the user 12 performs another gesture that does not mimic how the window shade 40 opens. For example, a performance of a clapping gesture or a horizonal drag gesture does not trigger the window shade 40 to open further because neither the clapping gesture nor the horizontal drag gesture mimic how the window shade 40 opens. The drag gesture 128 allows the user 12 to open the window shade 40 in an intuitive manner by performing a gesture that mimics how the window shade 40 opens. Advantageously, the user 12 does not need to remember a specific voice command or a pre-authored gesture for controlling the window shade 40.

FIGS. 1H-1J illustrate a sequence for controlling the door lock 50. Referring to FIG. 1H, the device 20 detects a gaze input 130 directed to the door lock 50 while the door lock 50 is in a locked position. Additionally, the device 20 detects the hand 120 with the thumb 122 and the index finger 124. In the example of FIG. 1H, the thumb 122 and the index finger 124 are pointing in a left direction.

Referring to FIG. 1I, the device 20 detects a performance of a rotating gesture 132 in which the hand 120 rotates so that that thumb 122 and the index finger 124 are pointing in a right direction that is opposite to the left direction shown in FIG. 1H. The system 200 determines that the rotating gesture 132 is within a similarity threshold of a rotational movement that the door lock performs to switch between the locked position and the unlocked position as indicated by the curved arrow 52.

Referring to FIG. 1J, in response to detecting the rotating gesture 132 and determining that the rotating gesture 132 matches a rotational movement 54 of the door lock 50, the system 200 transmits a command to a controller of the door lock 50 to switch the door lock from a locked position 56a to an unlocked position 56b. In some implementations, the device 20 displays a notification 58 indicating that the door lock 50 is being unlocked. In some implementations, the notification 58 provides an option to cancel the unlocking operation, for example, by displaying a ‘Cancel’ GUI element that the user can select via gaze and the air tap gesture 126 shown in FIG. 1D.

FIGS. 1K-1M illustrate another sequence for controlling the door lock 50. Referring to FIG. 1K, after detecting the gaze input 130 directed to the door lock 50, the device 20 detects a palm 125P and a forearm 125F of the user 12. The device 20 detects that the palm 125P is bent such that the palm 125P and forearm 125F approximately form a right angle. Furthermore, the thumb 122 and the index finger 124 are pointing towards the left. In the example of FIG. 1K, the palm 125P is aligned horizontally with the door lock 50 in the locked position.

Referring to FIG. 1L, the device 20 detects a rotational movement 134 of the palm 125P. After the rotational movement 134, the palm 125P and the forearm 125F are vertically aligned and approximately form a 180 degree angle. Furthermore, in FIG. 1L, the thumb 122 and the index finger 124 are pointing upwards. The system 200 determines that the rotational movement 134 of the palm 125P is within a similarity threshold of the rotational movement of the door lock 50 indicated by the curved arrow 52.

Referring to FIG. 1M, in response to determining that the rotational movement 134 of the palm 125P matches the rotational movement 54 of the door lock 50 from the locked position 56a to the unlocked position 56b, the system 200 switches a state of the door lock 50 from the locked position 56a to the unlocked position 56b.

As illustrated in FIGS. 1H-1M, different gestures can trigger the same state change in a physical object so long as the gestures are similar to how the physical object moves when transitioning between states. For example, while the rotating gesture 132 shown in FIG. 1I and the rotational movement 134 of the palm 125P shown in FIG. 1L are different, the system 200 triggers a state change in the door lock 50 from the locked position 56a to the locked position 56b because the rotating gesture 132 and the rotational movement 134 of the palm 125P mimic how the door lock 50 moves when transitioning from the locked position 56a to the locked position 56b.

FIGS. 1N-1Q illustrate a sequence for controlling a brightness of the light bulb 92. As illustrated in FIG. 1N, the device 20 detects a gaze input 140 directed to the lamp 90 or the light bulb 92.

Referring to FIG. 1O, the device 20 detects that the hand 120 of the user 12 is facing upwards (e.g., the palm is facing towards a ceiling of the physical environment 10). The thumb 122 and the index finger 124 are pointing away from the user 12.

Referring to FIG. 1P, the system 200 detects an upward movement 142 of the hand 120 while the hand 120 is facing upwards. For example, the device 20 detects that the user 12 moves his/her palm upwards towards the ceiling of the physical environment 10 while maintaining the palm open. The system 200 determines that the upward movement 142 of the hand 120 matches an upward direction of the vertical arrow 94 in which a brightness value of the light bulb 92 can move.

Referring to FIG. 1Q, in response to determining that the gesture represented by the upward movement 142 matches a direction in which the brightness value of the light bulb 92 can increase, the system 200 transmits a command to a controller of the light bulb 92 to increase the brightness value of the light bulb 92. If the light bulb 92 is currently off, the upward movement 142 results in the light bulb 92 being turned on. If the light bulb 92 is already on, the upward movement 142 of the hand 120 results in the brightness value of the light bulb 92 being increased. As indicated by the appearance of a brightness indicator 96, the brightness of the light bulb 92 has increased. In some implementations, the device 20 displays a notification 98 indicating that the brightness of the light bulb 92 is being increased. The brightness value of the light bulb 92 moves in the same direction as the hand 120. As such, when the user 12 moves his/her hand 120 downwards, the system 200 decreases the brightness value of the light bulb 92.

FIGS. 1R-1S illustrate a sequence for controlling the fan 60. Referring to FIG. 1R, the device 20 detects a gaze input 144 directed to the fan 60. Additionally, the device 20 detects that the user 12 is pointing his/her index finger 124 to form a pointing gesture. In the example of FIG. 1R, the user 12 is pointing towards the fan 60.

In FIG. 1S, the device 20 detects a rotational gesture 146 being performed by the index finger 124. For example, the user 12 rotates his/her index finger 124 in a clockwise direction to mimic how the fan blades 62 rotate in the direction of the curved arrow 64. In response to detecting the rotational gesture 146 and determining that the rotational gesture 146 is within a similarity threshold of how the fan blades 62 rotate, the system 200 instructs a controller of the fan 60 to turn on. As such, the fan blades 62 begin a rotational movement 66 as the fan 60 turns on. If the fan 60 is already on, the rotational gesture 146 triggers the fan blades 62 to rotate faster. The device 20 may display a notification 68 indicating that the fan 60 is being turned on.

FIG. 1T illustrates that the system 200 can turn the fan 60 on in response to a concurrent occurrence of the gaze input 144 and a voice gesture as an alternative to a concurrent occurrence of the gaze input 144 and the rotational gesture 146 shown in FIG. 1S. In the example of FIG. 1T, the device 20 detects an utterance 148 by the user 12. The system 200 compares the utterance 148 with a fan sound 150 to determine whether the utterance 148 represents a voice gesture that is within a similarity threshold of a sound that the fan 60 makes when the fan 60 is turned on. In some implementations, the system 200 determines whether a frequency range of the utterance 148 matches a frequency range of the fan sound 150. For example, the system 200 determines whether the utterance 148 is similar to a low-pitched whirling sound that the fan 60 makes during operation. In the example of FIG. 1T, the system 200 determines that the utterance 148 matches the fan sound 150. As such, the system 200 causes the fan 60 to turn on and the fan blades 62 begin the rotational movement 66.

FIGS. 1U-1W illustrate a sequence for controlling the window 30. Referring to FIG. 1U, the device 20 detects a gaze input 152 directed to the window 30. Referring to FIG. 1V, the device 20 detects a swipe gesture 154 by detecting a movement of the index finger 124 rightwards within a relatively short time duration. The system 200 determines that the swipe gesture 154 is within a similarity threshold of how the window 30 moves. For example, the system 200 determines that the rightward movement of the swipe gesture 154 aligns with a rightward direction of the horizontal arrow 32.

Referring to FIG. 1W, in response to determining that the swipe gesture 154 matches how the window 30 moves, the system 200 transmits a command to a controller for the window 30 which instructs an actuator to perform a window movement 34 towards the right.

FIG. 1W illustrates that the user 12 has a left ear 14L and a right ear 14R. In the example of FIG. 1W, the left ear 14L and the right ear 14R are both visible. FIG. 1X illustrates a head gesture that triggers a movement of the window 30 as an alternative to the swipe gesture 154 shown in FIG. 1V. As illustrated in FIG. 1X, the device 20 detects a rightward head turn 156. After the rightward head turn 156, the left ear 14L is out of the view and only the right ear 14R is viewable in FIG. 1X. The system 200 determines that the rightward head turn 156 is within a similarity threshold of how the window 30 moves, for example, because the window 30 moves left-to-right and right-to-left. As such, the system 200 triggers the window movement 34 of the window 30 towards a closed state.

FIGS. 1Y-1Z illustrate a sequence for controlling the thermostat 100. In FIG. 1Y, the device 20 detects a gaze input 158 directed to the thermostat 100. Additionally, the device 20 detects the hand 120 in an open position where the thumb 122 and the index finger 124 are separated. Referring to FIG. 1Z, the device 20 detects a rotational gesture 160 that includes a rightward rotational movement of a wrist, the thumb 122 and the index finger 124 about an axis that aligns with (e.g., is parallel to) a forearm of the user 12. As depicted in FIG. 1Z, the thumb 122 and the index finger 124 are overlapping with the thumb 122 being over the index finger 124. In some implementations, the rightward rotational movement depicted in FIG. 1Z satisfies a state change criterion for increasing the temperature value 102. As such, the system 100 increases the temperature value 102 from 72 degrees to 74 degrees. The device 20 may display a notification 106 indicating that the temperature value 102 is being increased in response to the rotational gesture 160. In some implementations, a leftward rotational gesture results in the temperature value 102 being decreased. In some implementations, a degree of the rotational gesture 160 affects a change in the temperature value 102. For example, a rotational movement that is less than a threshold number of degrees results in a first increase in the temperature value 102, whereas a rotational movement that is greater than the threshold number of degrees results in a second increase in the temperature value 102. As an example, a rotational movement of less than 15 degrees results in a temperature increase of two degrees, whereas a rotational movement of greater than 15 degrees results in a temperature increase of four degrees.

FIG. 1AA-1AC illustrate another sequence for controlling the thermostat 100. Referring to FIG. 1AA, in response to detecting the gaze input 158 directed to the thermostat 100, the device 20 displays a GUI 162 for changing the temperature value 102. The GUI 162 includes a GUI element 164 that can be moved along a circular track 166 in order to change the temperature value 102.

FIG. 1AB shows the user 12 virtually grabbing the GUI element 164 by performing an air tap gesture at a display location that corresponds to the GUI element 164. FIG. 1AC shows the user 12 moving the GUI element 164 along the circular track 166 to a display location that corresponds to the 77 degrees. As such, the system 200 transmits a command to the thermostat to change the temperature value 102 to 77 degrees.

FIG. 1AD-1AE illustrate a sequence for controlling the robot 70. FIG. 1AD illustrates a gaze input 168 directed to the robot 70. Additionally, FIG. 1AD shows the hand 120 in an open position with the palm facing up.

FIG. 1AE shows the user 12 performing an invitation gesture 170 (e.g., a beckoning gesture) by curling the index finger 124 towards the user 12. The system 200 determines that the invitation gesture 170 corresponds to a request for the robot 70 to move towards the user 12. Since the robot 70 can move in any direction, the system 200 determines that the invitation gesture 170 satisfies a state change criterion for the robot 70 to move towards the user 12. As such, the system 200 transmits a command to the robot 70 instructing the robot 70 to perform a movement 74 towards the user 12.

FIG. 1AF-1AG illustrate another sequence for controlling the robot 70. In FIG. 1AF, while the gaze input 168 is directed to the robot 70, the device 20 detects the hand 120 in a straight position where the thumb 122, the index finger 124 and other fingers of the hand 120 are pointing upwards.

FIG. 1AG shows the user 12 performing a repelling gesture 172 (e.g., a dismissal gesture) by waiving the hand away from the user 12 so that the hand 120 rotates away from the user 12. The system 200 determines that the repelling gesture 172 corresponds to a request for the robot 70 to move away from the user 12. Since the robot 70 can move in any direction, the system 200 determines that the repelling gesture 172 satisfies a state change criterion for the robot 70 to move away from the user 12. As such, the system 200 transmits a command to the robot 70 instructing the robot 70 to perform a movement 76 towards the dock 80.

FIG. 1AH-1AI illustrate a sequence for guiding the user 12. FIG. 1AH illustrates a gaze input 174 that is not directed to a single physical object in particular. As illustrated in FIG. 1AH, the gaze input 174 encompasses the window 30, the window shade 40 and the door lock 50. The gaze input 174 may be spread across multiple physical objects due to an error in tracking the gaze. Additionally or alternatively, the gaze input 174 may be spread across multiple physical objects due to excessive saccades. Since the gaze input 174 encompasses multiple physical objects, it may not be feasible for the system 200 to determine which physical object the user 12 wants to control until the user 12 performs an object-specific gesture.

Referring to FIG. 1AI, the system 200 displays a notification 176 with graphics for various gestures that the user 12 can perform in order to control the physical objects that are encompassed by the gaze input 174. In the example of FIG. 1AI, the notification 176 shows that the user 12 can perform a pinch-and-drag gesture to control the window shade 40, a rotational gesture to unlock the door lock 50, and a swipe gesture to control the window 30.

Referring to FIG. 1AJ, in some implementations, the device 20 obtains an input from a physical dial 180 that is rotatable in a first direction or a second direction. In some implementations, the device 20 includes the physical dial 180. For example, in some implementations, the device 20 includes an HMD and the physical dial 182 is located on a body of the HMD. In such implementations, the physical dial 180 can be rotated in a clockwise direction or a counterclockwise direction. Alternatively, in some implementations, the physical dial 180 is a part of another device. For example, the physical dial 180 is a part of an electronic watch. In this example, the physical dial 180 can be rotated in an upward direction away from the user 12 or a downward direction towards the user 12.

In the example of FIG. 1AJ, the device 20 detects a rotational gesture 182 directed to the physical dial 180 while the gaze input 110 is directed to the window shade 40. The rotational gesture 182 is in a clockwise direction. In the example of FIG. 1AJ, the rotational gesture 182 in the clockwise direction triggers the window shade 40 to move up from the first position 44a to the second position 44b. In the example of FIG. 1AJ, an opposite rotational gesture in a counterclockwise direction triggers the window shade 40 to move downwards.

More generally, in various implementations, a rotational gesture detected at the physical dial 180 in a first direction triggers a first state change in a gazed-upon physical object and a rotational gesture detected at the physical dial 180 in a second direction triggers a second state change in the gazed-upon physical object. The user 12 can provide a rotational gesture via the physical dial 180 to control another physical object depicted in FIG. 1AJ. For example, rotating the physical dial 180 in a first direction while gazing at the light bulb 92 triggers a brightening of the light bulb 92, and rotating the physical dial 180 in a second direction while gazing at the light bulb 92 triggers a dimming of the light bulb 92. As another example, rotating the physical dial 180 in a first direction while gazing at the robot 70 triggers the robot 70 to move towards the user 12, and rotating the physical dial 180 in a second direction while gazing at the robot 70 triggers the robot 70 to move away from the user 12 and towards the dock 80. As yet another example, rotating the physical dial 180 in a first direction while gazing at the fan 60 triggers the fan blades 61 to speed up, and rotating the physical dial 180 in a second direction while gazing at the fan 60 triggers the fan blades 61 to slow down. As yet another example, rotating the physical dial 180 in a first direction while gazing at the door lock 50 triggers the door lock 50 to unlock if the door lock 50 is currently locked, and rotating the physical dial 180 in a second direction while gazing at the door lock 50 triggers the door lock 50 to lock if the door lock 50 is currently unlocked.

In some implementations, the physical dial 180 is a part of the device 20, and the device 20 displays a representation of the physical object that the user 12 is currently gazing at. In the example of FIG. 1AJ, the device 20 displays a virtual representation of the window shade 40 and the virtual representation of the window shade 40 mimics the movement of the window shade 40 as the user 12 turns the physical dial 180. In some implementations, the physical dial 180 is a part of an electronic watch and the electronic watch displays the virtual representation of the physical object that is currently being controlled via the physical dial 180.

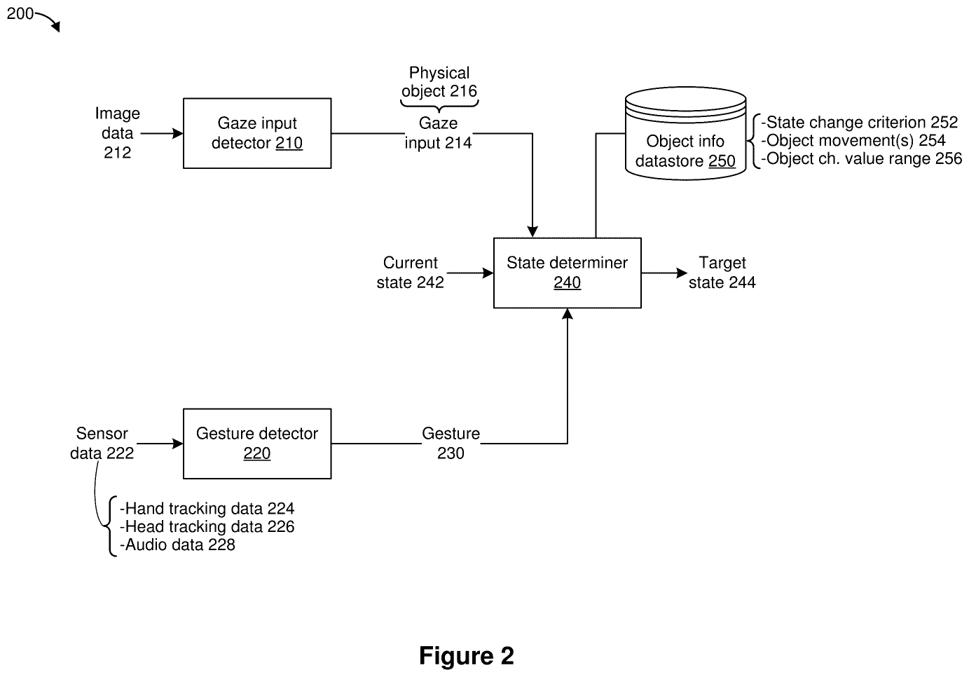

FIG. 2 is a block diagram of the system 200 in accordance with some implementations. In some implementations, the system 200 includes a gaze input detector 210, a gesture detector 220, a state determiner 240 and an object information datastore 250.

In various implementations, the gaze input detector 210 obtains image data 212 from an image sensor (e.g., a user-facing camera, for example, an eye tracking camera). The gaze input detector 210 analyzes the image data 212 in order to detect a gaze input 214. The gaze input 214 identifies a physical object 216 that a user is gazing at. As an example, referring to FIG. 1B, the gaze input detector 210 detects the gaze input 110 directed to the window shade 40. The gaze input detector 210 provides the gaze input 214 to the state determiner 240.

In various implementations, the gesture detector 220 obtains sensor data 222 from a sensor. In some implementations, the sensor data 222 includes hand tracking data 224 from an image sensor that captures images of a hand of the user. In some implementations, the sensor data 222 includes head tracking data 226 from an inertial measurement unit (IMU) or an image sensor. In some implementations, the sensor data 222 includes audio data 228 from an audio sensor (e.g. a microphone).

In some implementations, the gesture detector 220 utilizes the sensor data 222 to identify a gesture 230 performed by the user. In some implementations, the gesture 230 includes a hand gesture indicated by the hand tracking data 224. For example, the gesture 230 includes the air tap gesture 126 shown in FIG. 1D, the drag gesture 128 shown in FIG. 1E, the rotating gesture 132 shown in FIG. 1I, the rotational movement 134 shown in FIG. 1L, the upward movement 142 shown in FIG. 1P, the rotational gesture 146 shown in FIG. 1S, the swipe gesture 154 shown in FIG. 1V, the rotational gesture 160 shown in FIG. 1Z, the manipulation of the GUI element 164 shown in FIG. 1AB-1AC, the invitation gesture 170 shown in FIG. 1AE, or the repelling gesture 172 shown in FIG. 1AG. In some implementations, the gesture 230 indicates a type of hand movement performed by the user, for example, a vertical drag gesture, a horizontal drag gesture, a wrist rotating gesture, a finger rotating gesture, an invitation gesture, a repelling gesture, etc.

In some implementations, the gesture 230 includes a head gesture indicated by the head tracking data 226. For example, the gesture 230 includes the rightward head turn 156 shown in FIG. 1X. In some implementations, the gesture 230 indicates a type of head movement performed by the user, for example, a vertical nod, a horizontal shaking of the head, a swiping of the head in a particular direction, etc.

In some implementations, the gesture 230 includes a voice gesture indicated by the audio data 228. For example, the gesture 230 includes the utterance 148 shown in FIG. 1T. In some implementations, the gesture 230 indicates a type of voice gesture, for example, a low-pitched voice gesture, a high-pitched voice gesture, a humming sound, a whirling sound, etc.

In various implementations, the state determiner 240 obtains an indication of the gaze input 214 and the gesture 230. The state determiner 240 obtains an indication of a current state 242 of the physical object 216. For example, referring to FIG. 1B, the state determiner 240 determines that the window shade 40 is in a half-open state. The state determiner 240 determines a target state 244 for the physical object 216 based on the gesture 230.

In some implementations, the object information datastore 250 stores respective state change criterion 252 for various physical objects. For example, referring to FIG. 1F, the state change criterion 252 for the window shade 40 includes an upward drag gesture for raising the window shade 40 and a downward drag gesture for lowering the window shade 40.

As another example, referring to FIG. 1J, the state change criterion 252 for the door lock 50 includes the rotating gesture 132 for switching the door lock 50 from the locked position 56a to the unlocked position 56b. As yet another example, referring to FIG. 1M, another state change criterion 252 for the door lock 50 includes the rotational movement 134 of the palm 125P to switch the door lock 50 from the locked position 56a to the unlocked position 56b.

As yet another example, referring to FIG. 1Q, the state change criterion 252 for increasing a brightness value of the light bulb 92 includes the upward movement 142 and the state change criterion 252 for decreasing the brightness value of the light bulb 92 includes an opposing downward movement.

As yet another example, referring to FIG. 1S, the state change criterion 252 for turning the fan 60 on or increasing a speed of the fan 60 if the fan 60 is already on includes the rotational gesture 146. As a further example, referring to FIG. 1T, another state change criterion 252 for turning the fan 60 on or increasing a speed of the fan 60 includes the utterance 148.

As another example, referring to FIG. 1W, the state change criterion 252 for the window 30 includes the swipe gesture 154 for moving the window 30. As yet another example, referring to FIG. 1X, another state change criterion 252 for the window 30 includes the rightward head turn 156 to close the window 30.

As yet another example, referring to FIG. 1Z, the state change criterion 252 for the thermostat 100 includes the rotational gesture 160 for increasing the temperature value 102 and an opposing leftward rotational gesture for decreasing the temperature value 102. As a further example, referring to FIG. 1AC, another state change criterion 252 for the thermostat 100 includes dragging the GUI element 164 in a clockwise direction along the circular track 166 to increase the temperature value 102 and dragging the GUI element 164 in a counterclockwise direction along the circular track 166 to decrease the temperature value 102.

As yet another example, referring to FIG. 1AE and 1AG, the state change criterion 252 for the robot 70 includes detecting the invitation gesture 170 for summoning the robot 70 towards the user 12 and the repelling gesture 172 for dismissing the robot 70.

In some implementations, the object information datastore 250 stores information regarding respective object movements 254 that corresponding physical objects perform when switching between states. As an example, referring to FIG. 1A, the object movements 254 indicate that the window 30 moves horizontally as indicated by the horizontal arrow 32, the window shade 40 moves vertically as indicated by the vertical arrow 42, the door lock 50 rotates between a locked state and an unlocked state as indicated by the curved arrow 52, the fan blades 62 rotate as indicated by the curved arrow 62, and the robot 70 moves in various directions indicated by the arrows 72. In some implementations, the system 200 determines the object movements 254 based on previous interactions of the user 12 with the physical objects. For example, the system 200 determines that the window 30 moves horizontally by detecting the user 12 manipulating the window 30 horizontally. In some implementations, the state change criterion 252 is a function of the object movements 254. For example, the system 200 (e.g., the state determiner 240) determines the state change criterion 252 based on the object movements 254.

In some implementations, the object information datastore 250 stores characteristic value ranges 256 that various physical objects exhibit as the physical objects undergo state changes. As an example, referring to FIG. 1A, the characteristic value ranges 256 indicate that the brightness of the light bulb 92 increases or decreases as indicated by the vertical arrow 94, and the temperature value 102 increases or decreases as indicated by the bi-directional vertical arrow 104. In some implementations, the state change criterion 252 is a function of the characteristic value ranges 256. For example, the system 200 (e.g., the state determiner 240) determines the state change criterion 252 based on the characteristic value ranges 256.

In some implementations, the state determiner 240 determines whether the gesture 230 satisfies the state change criterion 252 for switching the physical object 216 from the current state 242 to the target state 244. In response to determining that the gesture 230 satisfies the state change criterion 252, the state determiner 240 switches the physical object 216 from the current state 242 to the target state 244. In response to determining that the gesture 230 does not satisfy the state change criterion 252, the state determiner 240 forgoes switching the physical object 216 from the current state 242 to the target state 244 and maintains the physical object 216 in the current state 242.

In some implementations, the gesture 230 satisfies the state change criterion 252 when the gesture 230 is of a gesture type specified by the state change criterion 252. For example, referring to FIG. 1F, the drag gesture 128 satisfies the state change criterion 252 for moving the window shade 40 up because the drag gesture 128 is an upward drag gesture specified by the state change criterion 252 for the window shade 40. In some implementations, the gesture 230 does not satisfy the state change criterion 252 when the gesture 230 is not of the gesture type specified by the state change criterion 252. For example, referring to FIG. 1D, the air tap gesture 126 on its own does not satisfy the state change criterion 252 for moving the window shade 40 up or down.

In some implementations, the gesture 230 satisfies the state change criterion 252 when the gesture 230 is within a similarity threshold of the object movement 254. For example, referring to FIG. 1M, the rotational movement 134 of the palm 125P satisfies the state change criterion 252 for switching the door lock 50 from the locked position 56a to the unlocked position 56b because the rotational movement 134 of the palm 125P is within a similarity threshold of the rotational movement 54 of the door lock 50 when the door lock 50 switches from the locked position 56a to the unlocked position 56b.

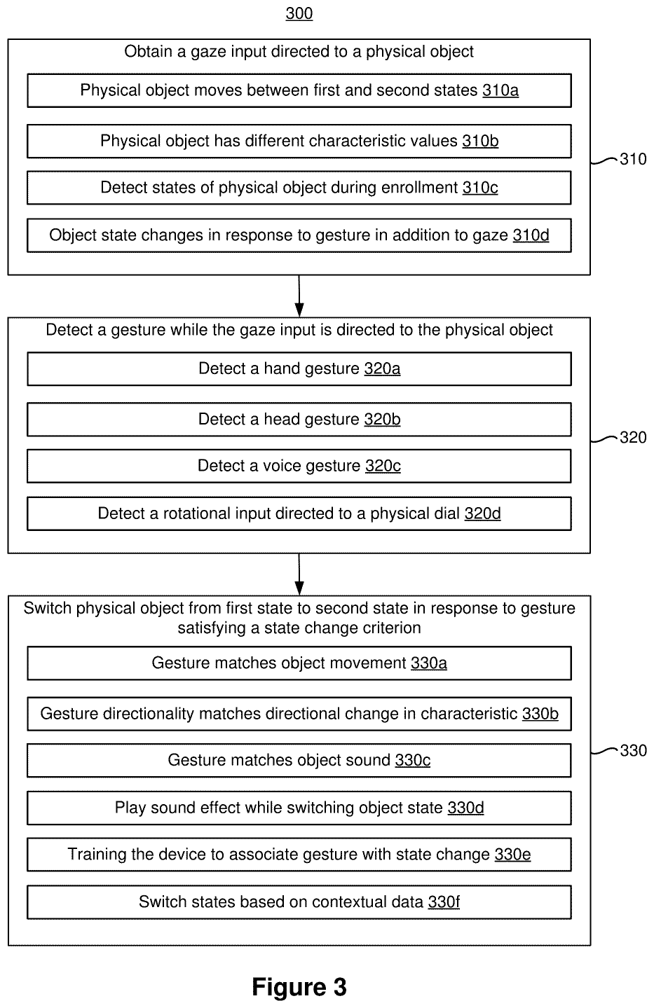

FIG. 3 is a flowchart representation of a method 300 for controlling a physical object based on a gesture. In various implementations, the method 300 is performed by a device including a display, a non-transitory memory and one or more processors coupled with the display and the non-transitory memory (e.g., the device 20 shown in FIGS. 1A-1AJ and/or the system 200 shown in FIGS. 1A-2). In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in various implementations, the method 300 includes obtaining, via the eye tracker, a gaze input directed to a physical object that is operable in a first state or a second state. The physical object is currently in the first state. For example, referring to FIG. 1B, the device 20 detects the gaze input 110 directed to the window shade 40. As another example, referring to FIG. 2, the gaze input detector 210 detects the gaze input 214 directed to the physical object 216 based on the image data 212.

As represented by block 310a, in some implementations, the physical object performs a particular type of movement to switch between the first state and the second state. In some implementations, the physical object performs a rotational movement to switch between the first state and the second state. For example, referring to FIG. 1A, the physical object is the fan 60 with the fan blades 62 that rotate between an off state and an on state as indicated by the curved arrow 62.

In some implementations, the physical object performs a sliding movement to switch between the first state and the second state. For example, the physical object performs a horizontal sliding movement, for example, the window 30 slides from left-to-right and vice versa as indicated by the horizontal arrow 32 shown in FIG. 1A. As another example, the physical object performs a vertical sliding movement, for example, the window shade 40 that slides from down-to-up and vice versa as indicated by the vertical arrow 42 shown in FIG. 1A.

In some implementations, the physical object performs a translational movement to switch between the first state and the second state. For example, the physical object performs a horizontal translational movement, for example, the physical object includes blinds that translate from side-to-side. As another example, the physical object performs a vertical translational movement, for example, the physical object includes blinds that translate from bottom-to-top.

In some implementations, the physical object performs a rolling movement to switch between the first state and the second state. For example, referring to FIG. 1A, the physical object includes the robot 70 with wheels that allow the robot 70 to move in any direction indicated by arrows 72. As another example, the physical object includes a toy car with wheels that allow the toy car to roll in various directions including towards or away from the user.

In some implementations, the physical object performs a to-and-fro movement to switch between the first state and the second state. For example, the physical object performs a rocking movement, for example, the physical object includes a baby swing that rocks back-and-forth. As another example, the physical object includes a rocking chair that rocks back and forth.

As represented by block 310b, in some implementations, the physical object is associated with a first characteristic value in the first state and a second characteristic value in the second state. For example, as shown in FIGS. 1P and 1Q, the light bulb 92 is associated with a first light intensity value when the light bulb 92 is off or dimly lit and the light bult 92 is associated with a second light intensity value when the light bulb 92 is on or brightly lit. As another example, as shown in FIGS. 1Y and 1Z, the thermostat 100 is associated with a first temperature value 102 of seventy-two degrees in the first state and a second temperature value 102 of seventy-four degrees in the second state.

As represented by block 310c, in some implementations, the device detects the first state and the second state during an enrollment phase when the physical object is enrolled into gesture-based control. For example, during the enrollment phase the user scans a bar code affixed to the physical object, or the user specifies a make and a model number of the physical object in order to identify the physical object. In some implementations, the device detects the first state and the second state at a previous time when the user physically moves the physical object between the first and second states. For example, referring to FIGS. 1E-1F, the device 20 identifies the window shade 40 when the user 12 grabs a bottom portion (e.g., a handle) of the window shade 40 and moves the window shade 40 up by applying an upward lift force on the handle of the window shade 40.

As represented by block 310d, in some implementations, the physical object is a particular type of object that changes states in response to a sequence of the gaze input and the gesture. In some implementations, a gaze input on its own is not enough to change the state of the physical object, and the device requires a gaze input and the gesture in order to change the state of the physical object.

In some implementations, the physical object is associated with a threshold level of security. For example, the physical object includes the door lock 50 shown in FIG. 1A that keeps the user 12 safe. In such implementations, triggering a change in a state of the physical object based solely on gaze may compromise security. For example, unlocking the door lock 50 shown in FIG. 1A based solely on gaze may inadvertently unlock the door for a stranger when the user 12 gazes at the door lock 50 to make sure that the door lock 50 is in the locked position and the user 12 does not intend to open the door for the stranger.

In some implementations, the physical object is associated with a threshold level of privacy. For example, the physical object includes the window shade 40 shown in FIG. 1A that provides the user 12 with privacy from people driving or walking on a road outside the window 30. In such implementations, triggering a change in a state of the physical object based solely on gaze may compromise privacy. For example, opening the window shade 40 shown in FIG. 1A based solely on gaze may inadvertently open the window shade 40 when the user 12 gazes at the window shade 40 to make sure that the window shade 40 is closed while the user 12 changes his/her clothes and the user 12 does not intend to open the window shade 40.

As represented by block 320, in some implementations, the method 300 includes detecting a gesture performed by a user of the device while the gaze input is directed to the physical object. For example, as shown in FIG. 1E, the device 20 detects the drag gesture 128 while the gaze input 110 is directed to the window shade 40. As another example, the device 20 detects the rotational gesture 146 while the gaze input 144 is directed to the fan 60.

As represented by block 320a, in some implementations, detecting the gesture includes tracking, via an image sensor, a hand of the user, and detecting the gesture being performed by the hand of the user. In some implementations, detecting the gesture includes detecting a movement of the hand along an axis (e.g., along a horizontal axis or a vertical axis). For example, as shown in FIG. 1E, the drag gesture 128 is performed along a vertical axis that is parallel to the vertical arrow 42.

In some implementations, detecting the gesture includes detecting a contact between a thumb of the hand and a finger of the hand, and detecting a movement of the hand along an axis while the contact is maintained. For example, as shown in FIG. 1E, the user 12 performs the drag gesture 128 while maintaining the contact between the thumb 122 and the index finger 124.

In some implementations, detecting the gesture includes detecting a rotation of the hand about an axis. For example, as shown in FIG. 1I, the device 20 detects the rotating gesture 132 by detecting a rotation of the hand 120 about an axis that passes through a forearm of the user 12. As another example, as shown in FIG. 1L, the device 20 detects the rotational movement 134 of the palm 125P about an imaginary Z axis coming out of the page.

In some implementations, the method 300 includes overlaying a user interface (UI) element onto a display location that corresponds to the physical object, and detecting a manipulation of the UI element by the hand. For example, as shown in FIG. 1AA-1AC, the device 20 presents the GUI 162 representing a ring interface when the user 12 gazes at the thermostat 100 and the device 20 detects the manipulation of the GUI element 164 along the circular track 166.

In some implementations, detecting the gesture includes detecting a finger of the hand being curled towards the user. For example, as shown in FIG. 1AE, the device 20 detects the invitation gesture 170 while the gaze input 168 is directed to the robot 70. In some implementations, detecting the gesture includes detecting a finger of the hand or the entire hand being waived away from the user. For example, as shown in FIG. 1AG, the device 20 detects the repelling gesture 172 while the gaze input 168 is directed to the robot 70.

In some implementations, detecting the gesture includes detecting a pointing gesture while the gaze input is directed to a physical object that can move to a location that the pointing gesture is pointing towards. For example, when the user points to a particular location within the physical environment while gazing at the robot 70, the device 20 causes the robot 70 to move to that particular location within the physical environment.

As represented by block 320b, in some implementations, detecting the gesture includes detecting a movement of a head of the user (e.g., a head gesture). In some implementations, the movement of the head includes a vertical movement of the head such as a nod, a horizontal movement of the head and/or a rotational movement of the head. As an example, referring to FIG. 1X, the device 20 detects the rightward head turn 156 while the gaze input 144 is directed to the window 30.

As represented by block 320c, in some implementations, detecting the gesture includes detecting, via an audio sensor, a sound uttered by the user (e.g., a voice gesture). In some implementations, the user makes the same sound that the physical object makes when the physical object moves. For example, as shown in FIG. 1T, the device 20 detects the utterance 148 from the user 12.

As represented by block 320d, in some implementations, detecting the gesture includes detecting a rotational input directed to a physical dial. For example, referring to FIG. 1AJ, the device 20 detects the rotational gesture 182 directed to the physical dial 180. In some implementations, the user is wearing an electronic watch that includes the physical dial (e.g., the physical dial 180 shown in FIG. 1AJ is a part of an electronic watch that the user 12 is wearing on his/her wrist). The user can rotate the physical dial in a first direction (e.g., upwards, away from the user or clockwise) or in an opposing second direction (e.g., downwards, towards the user or counterclockwise). In some implementations, the user rotates the physical dial on the electronic watch in the first direction or the second direction while gazing at the physical object. For example, the user rotates the physical dial on his/her electronic watch while gazing at the window shade 40 (shown in FIG. 1A) that can be rolled up or down. Rotating the physical dial in the first direction triggers a first state change and rotating the physical dial in the second direction triggers a second state change that is different from the first state change.

As represented by block 330, in some implementations, the method 300 includes switching the physical object from the first state to the second state in response to the gesture satisfying a state change criterion associated with the second state. For example, as shown in FIGS. 1E-1G, the device 20 switches the state of the window shade 40 from half-open to fully open in response to the drag gesture 128 satisfying a state change criterion to switching the window shade 40 to the fully open state (e.g., in response to determining that the drag gesture 128 is an upward vertical gesture).

In some implementations, the method 300 includes maintaining the physical object in the first state in response to the gesture not satisfying the state change criterion associated with the second state. For example, as shown in FIG. 1D, the device 20 maintains the window shade 40 in the half-open state in response to determining that the air tap gesture 126 on its own (e.g., a static air tap gesture) does not satisfy the state change criterion associated with moving the window shade 40 to the fully open state.

In some implementations, the method 300 includes switching the physical object from the first state to a third state in response to the gesture satisfying a state change criterion associated with the third state. For example, referring to FIGS. 1E-1G, a downward drag gesture while gazing at the window shade 40 triggers the window shade 40 to move to a fully closed state.

In some implementations, the gesture satisfies the state change criterion when the gesture is within a similarity threshold of a particular type of movement that the physical object performs when transitioning between the first state and the second state. For example, referring to FIGS. 1K-1M, the rotational movement 134 of the palm 125P satisfies the state change criterion associated with the door lock 50 because a similarity score of the rotational movement 134 is greater than a similarity threshold indicating that the rotational movement 134 is within the similarity threshold of (e.g., sufficiently similar to) the rotational movement 54 that the door lock 50 performs.

In some implementations, the gesture does not satisfy the state change criterion when the gesture is not within the similarity threshold of the particular type of movement that the physical object performs when transitioning between the first state and the second state. As an example, a drag gesture performed while gazing at the fan 60 shown in FIG. 1A does not trigger the fan blades 62 to rotate because a similarity score of the drag gesture is less than a similarity threshold indicating that the drag gesture is not within the similarity threshold of a rotational movement that the fan blades 62 perform. As another example, a rotational gesture performed while gazing at the window 30 that slides open and close does not trigger the window 30 to open or close because a similarity score of the rotational gesture is less than a similarity threshold indicating that the rotational gesture is not within a similarity threshold of a horizontal movement that the window 30 performs.

In some implementations, the gesture satisfies the state change criterion when the physical object moves along a first axis and the gesture includes a movement of a body part along the first axis. For example, as shown in FIG. 1F, the window shade 40 slides along a vertical axis and the gesture includes the drag gesture 128 along the vertical axis. In some implementations, the gesture includes a movement of a head of the user. For example, referring to FIG. 1F, the user 12 can tilt his/her upwards to trigger an upward movement of the window shade 40.

In some implementations, the gesture satisfies the state change criterion when the physical object moves along a first axis and the gesture includes a contact between a thumb and a finger followed by a hand movement along the first axis while maintaining the contact between the thumb and the finger. For example, as described with respect to FIG. 1F, the window shade 40 translates along a vertical axis, and the gesture includes the air tap gesture 126 followed by the drag gesture 128 along the vertical axis. In some implementations, switching the physical object from the first state to the second state comprises moving the physical object from a first position to a second position along the first axis. For example, as shown in FIG. 1F, the device 20 moves the window shade 40 from the first position 44a to the second position 44b. As another example, referring to FIG. 1A, performance of a drag gesture along a horizontal axis while gazing at the window 30 that slides right to left, triggers opening/closing of the window 30.

In some implementations, the gesture satisfies the state change criterion when the physical object rotates and the gesture includes a rotational gesture. For example, as shown in FIG. 1I, the door lock 50 rotates and the user 12 performs the rotating gesture 132 while gazing at the door lock 50. In some implementations, switching the physical object from the first state to the second state includes rotating a portion of the physical object in response to detecting the rotational gesture. For example, as shown in FIG. 1J, the device 20 rotates the door lock 50 between the locked position 56a and the unlocked position 56b. As another example, referring to FIG. 1S, the device 20 rotates the fan blades 62 in response to the rotational gesture 146.

In some implementations, the gesture satisfies the state change criterion when the physical object moves in a first direction and the gesture includes a swipe gesture in the first direction. In some implementations, the swipe gesture includes a hand swipe gesture (e.g., the swipe gesture 154 shown in FIG. 1W). Alternatively, in some implementations, the swipe gesture includes a head swipe gesture (e.g., the rightward head turn 156 shown in FIG. 1X). In some implementations, switching the physical object from the first state to the second state includes moving the physical object from a first position to a second position in the first direction in response to detecting the swipe gesture. For example, in FIG. 1W, the device 20 closes the window 30 in response to the swipe gesture 154.

In some implementations, the gesture satisfies the state change criterion when the physical object is capable of moving towards the device and the gesture includes a beckoning gesture or an invitation gesture. For example, as shown in FIG. 1AE, the user 12 performs the invitation gesture 170 in order to summon the robot 70 towards him/her. In some implementations, switching the physical object from the first state to the second state includes moving the physical object towards the user in response to detecting the beckoning gesture or the invitation gesture. For example, as shown in FIG. 1AE, the robot 70 moves towards the user 12 in response to the invitation gesture 170.

In some implementations, the gesture satisfies the state change criterion when the physical object is capable of moving away from the device and the gesture includes a dismissal gesture or a repelling gesture. For example, as shown in FIG. 1AG, the user 12 performs the repelling gesture 172 to send the robot 70 away from the user 12. In some implementations, switching the physical object from the first state to the second state includes moving the physical object away from the user in response to detecting the dismissal gesture or the repelling gesture. For example, as shown in FIG. 1AG, the device 20 sends the robot 70 away from the user 12 and to the dock 80.

As represented by block 330b, in some implementations, the gesture satisfies the state change criterion when a directionality of the gesture matches a direction associated with transitioning from the first state to the second state. In such implementations, switching the physical object from the first state to the second state includes changing a characteristic of the physical object from a first characteristic value to a second characteristic value that is different from the first characteristic value. For example, if the first state is associated with a first characteristic value and the second state is associated with a second characteristic value that is greater than the first characteristic value, the gesture satisfies the state change criterion when the gesture has an upward directionality. As an example, referring to FIG. 1Q, the device 20 increases a brightness of the light bulb 92 in response to detecting the upward movement 142 of the hand 120. In the example of FIG. 1Q, a downward movement of the hand 120 results in a decrease in the brightness of the light bulb 92.

As represented by block 330c, in some implementations, the gesture satisfies the state change criterion when an utterance is within a similarity threshold of a sound that the physical object makes when transitioning between the first state and the second state. In such implementations, switching the physical object from the first state to the second state includes switching the physical object from the first state to the second state in response to detecting the utterance. For example, as shown in FIG. 1T, the device 20 rotates the fan blades 62 in response to an audio characteristic of the utterance 148 matching an audio characteristic of the fan sound 150 (e.g., in response to a frequency range of the utterance 148 being within a threshold of a frequency range of the fan sound 150, for example, in response to the utterance 148 being similar to a low-pitched whirling sound that the fan 60 makes during operation).

As represented by block 330d, in some implementations, the method 300 includes playing a sound while switching the physical object from the first state to the second state. For example, as shown in FIG. 1F, the device 20 plays the shade lifting sound effect 46 while the window shade 40 is being lifted up. The shade lifting sound effect 46 may include a discrete clicking sound as the window shade 40 is moving upwards. In some implementations, the method 300 further includes playing a sound after the physical object has been switched to the second state. For example, referring to FIG. 1G, when movement of the window shade 40 has been completed the device 20 plays a shade lifted sound effect (e.g., a distinct tone indicating that the window shade 40 has reached the fully open state and cannot further be opened).

As represented by block 330e, in some implementations, the method 300 includes training the device to associate the gesture with switching the physical object from the first state to the second state by detecting a voice command while the user is performing the gesture during a training phase. For example, referring to FIG. 1Q, during a training phase or an enrollment phase, the user 12 gazes at the light bulb 92 and says “make it brighter” while performing the upward movement 142 with the hand 120. In this example, the system 200 associates the upward movement 142 of the hand 120 with increasing a brightness of the light bulb 92. As another example, referring to FIG. 1S, during the training phase or the enrollment phase, the user 12 gazes at the fan 60 and says “turn it on” while performing the rotational gesture 146. In this example, the system 200 associates the rotational gesture 146 with turning the fan 60 on. As another example, referring to FIG. 1AE, during the training phase or the enrollment phase, the user 12 gazes at the robot 70 and says “come here” while performing the invitation gesture 170. In this example, the system 200 associates the invitation gesture 170 with the robot 70 moving towards the user 12.

As represented by block 330f, in some implementations, the method 300 includes switching the physical object from the first state to the second state based further on contextual data that indicates a context of the user or the device. For example, if the user is reading a book and the user performs an air tap gesture while gazing at a lamp, an intensity of the lamp is increased instead of turning the lamp off. As another example, if the user gets in his car and looks at a rearview mirror when there is an obstruction such as a garage wall in front of the car, the device switches the car from park to reverse since the car cannot move forward through the garage wall.

In some implementations, the contextual data indicates a current activity of the user and user preference data indicates that the user prefers the second state over the first state when performing the current activity. For example, the user prefers a bright white light when reading instead of a dim yellow light.

In some implementations, the contextual data indicates a location of the device and user preference data indicates that the user prefers the second state over the first state when the device is at the particular location. For example, when the user looks at a smartphone in his kids'bedroom at night while putting the kids to bed, the smartphone plays a bedtime nursery rhyme playlist based on user preference data or a previous user selection of a bedtime nursery rhyme playlist in the kids'bedroom at nighttime. By contrast, in this example, the smartphone plays an ocean sound when the user brings the smartphone to a master bedroom at night based on user preference data or a previous user selection of the ocean sound in the master bedroom at night.

In some implementations, the contextual data indicates a current time and user preference data indicates that the user prefers the second state over the first state when the current time is within a threshold time period. For example, looking at a lamp and performing an air tap between 6 pm and 8 pm brightens the lamp. By contrast, in this example, performing the air tap gesture while gazing at the lamp after 9 am turns the lamp off.

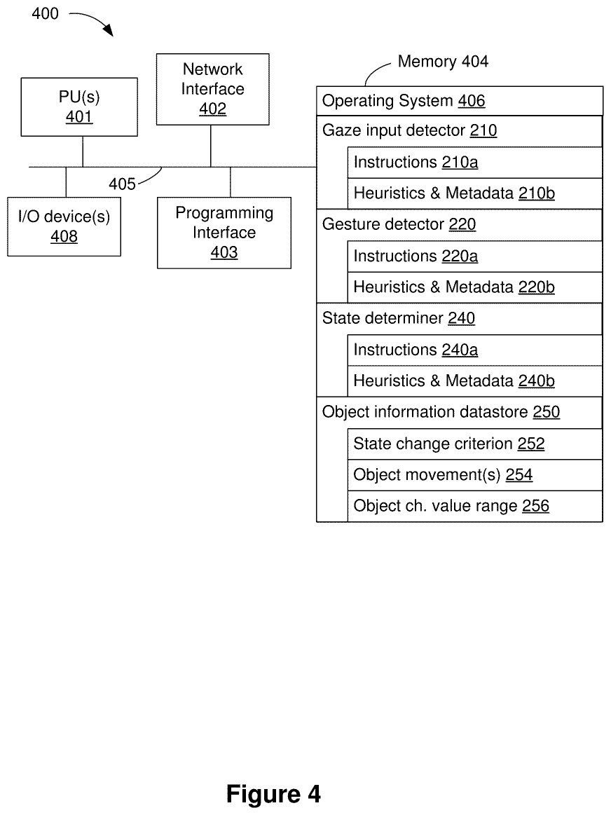

FIG. 4 is a block diagram of a device 400 in accordance with some implementations. In some implementations, the device 400 implements the device 20 shown in FIGS. 1A-1AJ and/or the system 200 shown in FIGS. 1A-2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (PUs) 401, a network interface 402, a programming interface 403, a memory 404, one or more input/output (I/O) devices 408, and one or more communication buses 405 for interconnecting these and various other components.

In some implementations, the PU(s) 401 includes one or more central processing units (CPU(s)), one or more graphics processing units (GPU(s)) and/or one or more neural processing units (NPU(s)).

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more PUs 401. The memory 404 comprises a non-transitory computer readable storage medium.

In some implementations, the memory 404 or the non-transitory computer readable storage medium of the memory 404 stores the following programs, modules and data structures, or a subset thereof including an optional operating system 406, the gaze input detector 210, the gesture detector 220, the state determiner 240 and the object information datastore 250. In various implementations, the device 400 performs the method 300 shown in FIG. 3.

In some implementations, the gaze input detector 210 includes instructions 210a, and heuristics and metadata 210b for detecting a gaze input (e.g., the gaze input 214 shown in FIG. 2). In some implementations, the gaze input detector 210 performs at least some of the operation(s) represented by block 310 in FIG. 3.

In some implementations, the gesture detector 220 includes instructions 220a, and heuristics and metadata 220b for detecting a gesture (e.g., the gesture 230 shown in FIG. 2). In some implementations, the gesture detector 220 performs at least some of the operation(s) represented by block 320 in FIG. 3.

In some implementations, the state determiner 240 includes instructions 240a, and heuristics and metadata 240b for switching a state of a physical object in response to the gesture satisfying a state change criterion. In some implementations, the state determiner 240 performs at least some of the operation(s) represented by block 330 in FIG. 3.

In some implementations, the one or more I/O devices 408 include an input device for obtaining an input (e.g., a gaze input such as the gaze input 214 shown in FIG. 2 and/or a gesture input such as the gesture 230 shown in FIG. 2). In some implementations, the one or more I/O devices 408 include an eye tracker for obtaining a gaze input. In some implementations, the one or more I/O devices 408 include one or more image sensors for detecting a gaze input and/or a gesture. For example, the one or more I/O devices 408 may include a user-facing camera of an HMD for capturing images of the user's eyes and a body-facing camera for detecting a hand gesture. In some implementations, the one or more I/O devices 408 include an inertial measurement unit (IMU) for detecting a head gesture (e.g., the rightward head turn 156 shown in FIG. 1X). In some implementations, the one or more I/O devices 408 include an audio sensor (e.g., a microphone) for detecting a voice gesture (e.g., the utterance 148 shown in FIG. 1T). In some implementations, the one or more I/O devices 408 include a display for displaying content (e.g., the GUI 162 shown in FIG. 1AA).

In various implementations, the one or more I/O devices 408 include a video pass-through display which displays at least a portion of a physical environment surrounding the device 400 as an image captured by a camera. In various implementations, the one or more I/O devices 408 include an optical see-through display which is at least partially transparent and passes light emitted by or reflected off the physical environment.

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at a device including an eye tracker, a display, non-transitory memory and one or more processors:
obtaining, via the eye tracker, a gaze input directed to a physical object that is operable in a first state or a second state, wherein the physical object is currently in the first state;
detecting a gesture performed by a user of the device while the gaze input is directed to the physical object; and
switching the physical object from the first state to the second state in response to the gesture satisfying a state change criterion associated with the second state.

2. The method of claim 1, wherein detecting the gesture comprises:
tracking, via an image sensor, a hand of the user; and
detecting the gesture being performed by the hand of the user.

3. The method of claim 2, wherein detecting the gesture comprises detecting a movement of the hand along an axis.

4. The method of claim 2, wherein detecting the gesture comprises:
detecting a contact of between a thumb of the hand and a finger of the hand; and
detecting a movement of the hand along an axis while the contact is maintained.

5. The method of claim 2, wherein detecting the gesture comprises detecting a rotation of the hand about an axis.

6. The method of claim 2, wherein detecting the gesture comprises detecting a finger of the hand being curled towards the user.

7. The method of claim 2, wherein detecting the gesture comprises detecting a finger of the hand being waived away from the user.

8. The method of claim 1, wherein detecting the gesture comprises detecting a rotational input directed to a physical dial.

9. The method of claim 1, wherein the gesture satisfies the state change criterion when the gesture is within a similarity threshold of a particular type of movement that the physical object performs when transitioning between the first state and the second state.

10. The method of claim 9, wherein the gesture does not satisfy the state change criterion when the gesture is not within the similarity threshold of the particular type of movement that the physical object performs when transitioning between the first state and the second state.

11. The method of claim 9, wherein the gesture satisfies the state change criterion when the physical object moves along a first axis and the gesture includes a movement of a body part along the first axis.

12. The method of claim 9, wherein the gesture satisfies the state change criterion when the physical object moves along a first axis and the gesture includes a contact between a thumb and a finger followed by a hand movement along the first axis; and
wherein switching the physical object from the first state to the second state comprises moving the physical object from a first position to a second position along the first axis.

13. The method of claim 9, wherein the gesture satisfies the state change criterion when the physical object rotates and the gesture includes a rotational gesture; and
wherein switching the physical object from the first state to the second state includes rotating a portion of the physical object in response to detecting the rotational gesture.

14. The method of claim 9, wherein the gesture satisfies the state change criterion when the physical object moves in a first direction and the gesture includes a swipe gesture in the first direction; and
wherein switching the physical object from the first state to the second state includes moving the physical object from a first position to a second position in the first direction in response to detecting the swipe gesture.

15. The method of claim 9, wherein the gesture satisfies the state change criterion when the physical object is capable of moving towards the device and the gesture includes a beckoning gesture or an invitation gesture; and
wherein switching the physical object from the first state to the second state includes moving the physical object towards the user in response to detecting the beckoning gesture or the invitation gesture.

16. The method of claim 9, wherein the gesture satisfies the state change criterion when the physical object is capable of moving away from the device and the gesture includes a dismissal gesture or a repelling gesture; and
wherein switching the physical object from the first state to the second state includes moving the physical object away from the user in response to detecting the dismissal gesture or the repelling gesture.

17. The method of claim 9, wherein the gesture satisfies the state change criterion when a directionality of the gesture matches a direction associated with transitioning from the first state to the second state; and
wherein switching the physical object from the first state to the second state includes changing a characteristic of the physical object from a first characteristic value to a second characteristic value that is different from the first characteristic value.

18. The method of claim 9, wherein the gesture satisfies the state change criterion when an utterance is within a similarity threshold of a sound that the physical object makes when transitioning between the first state and the second state; and
wherein switching the physical object from the first state to the second state includes switching the physical object from the first state to the second state in response to detecting the utterance.

19. A device comprising:
an eye tracker;
a sensor for detecting gestures;
a non-transitory memory; and
one or more processors to:
obtain, via the eye tracker, a gaze input directed to a physical object that is operable in a first state or a second state, wherein the physical object is currently in the first state;
detect a gesture performed by a user of the device while the gaze input is directed to the physical object; and
switch the physical object from the first state to the second state in response to the gesture satisfying a state change criterion associated with the second state.

20. A non-transitory memory storing one or more programs, which, when executed by one or more processors of a device including an eye tracker and a sensor for detecting gestures, cause the device to:
obtain, via the eye tracker, a gaze input directed to a physical object that is operable in a first state or a second state, wherein the physical object is currently in the first state;
detect a gesture performed by a user of the device while the gaze input is directed to the physical object; and
switch the physical object from the first state to the second state in response to the gesture satisfying a state change criterion associated with the second state.
